(19) United States
(12) Patent Application Publication
(10) Pub. No.: US 2025/0224249 A1
(43) Pub. Date: Jul. 10, 2025

(54) ELECTRONIC APPARATUS AND CONTROLLING METHOD THEREOF

(71) Applicant: SAMSUNG ELECTRONICS CO., LTD., Suwon-si (KR)

(72) Inventors: Gohwoon JEONG, Suwon-si (KR); Yunsung Jung, Suwon-si (KR)

(73) Assignee: SAMSUNG ELECTRONICS CO., LTD., Suwon-si (KR)

(21) Appl. No.: 19/030,267

(22) Filed: Jan. 17, 2025

Related U.S. Application Data
(63) Continuation of application No. PCT/KR2025/000138, filed on Jan. 3, 2025.

(30) Foreign Application Priority Data
Jan. 5, 2024 (KR) 10-2024-0002355
May 29, 2024 (KR) 10-2024-0043189

(51) Int. Cl. G01C 21/00; G01C 21/20

(52) U.S. Cl. CPC G01C 21/3837; G01C 21/206

(57) ABSTRACT

An electronic apparatus includes memory; at least one sensor; at least one processor operatively connected with the memory and the at least one sensor, and configured to execute instructions, wherein the instructions, when executed by the at least one processor, cause the electronic apparatus to: based on receiving a request for a map corresponding to a target space, obtain first surface data for a first surface corresponding to a driving direction of the electronic apparatus based on first sensor data obtained through the at least one sensor in first driving for the target space, obtain second surface data for a second surface different from the first surface based on second sensor data obtained through the at least one sensor in second driving for the target space, and obtain the map based on the first surface data and the second surface data.

### CROSS-REFERENCE TO RELATED APPLICATION

This application is a bypass continuation of International Application No. PCT/KR2025/000138, filed on Jan. 3, 2025, which is based on and claims priority to Korean Patent Application No. 10-2024-0002355, filed on Jan. 5, 2024, in the Korean Intellectual Property Office, and Korean Patent Application No. 10-2024-0043189, filed on Mar. 29, 2024, in the Korean Intellectual Property Office, the disclosures of which are incorporated by reference herein in their entireties.

### BACKGROUND

### 1. Field

The disclosure relates to an electronic apparatus and a controlling method thereof, and more particularly, to an electronic apparatus that provides a map for a space wherein the electronic apparatus exists, and a controlling method thereof.

### 2. Description of Related Art

A movable apparatus can provide various services based on a map for a space.

As an example, it is assumed that a movable apparatus is a projector. The projector may drive by using a map for a space.

As an example, it is assumed that a movable apparatus is a robot cleaner. The robot cleaner may perform a cleaning function by using a map for a space.

For obtaining a map for a space, a method by which an apparatus itself analyzes the space, or a user directly inputs information on the space exists.

In case an apparatus itself performs a function of analyzing a space, there are problems that the processing time takes long, or the precision deteriorates.

In case a user directly inputs information on a space, there are problems that the precision deteriorates, and the user's inconvenience is caused.

### SUMMARY

The disclosure was devised for improving the aforementioned problems, and the purpose of the disclosure is in providing an electronic apparatus that provides a map based on sensing data collected by dividing a horizontal plane and a second surface, and a controlling method thereof.

According to an aspect of the disclosure, an electronic apparatus includes: memory; at least one sensor; at least one processor operatively connected with the memory and the at least one sensor, and configured to execute instructions, wherein the instructions, when executed by the at least one processor, cause the electronic apparatus to: based on receiving a request for a map corresponding to a target space, obtain first surface data for a first surface corresponding to a driving direction of the electronic apparatus based on first sensor data obtained through the at least one sensor in first driving for the target space, obtain second surface data for a second surface different from the first surface based on second sensor data obtained through the at least one sensor in second driving for the target space, and obtain the map based on the first surface data and the second surface data.

The first surface data may include first information corresponding to a horizontal surface including an x axis and a y axis based on the driving direction of the electronic apparatus, and the second surface data may include second information corresponding to a vertical surface including a z axis based on the driving direction of the electronic apparatus.

The first surface data may include first spatial information of the first surface and first object information of the first surface.

The at least one sensor may include: a first distance sensor, and an acceleration sensor, the first sensor data may include first distance data obtained through the first distance sensor and first acceleration data obtained through the acceleration sensor, and the instructions, when executed by the at least one processor, may cause the electronic apparatus to: detect first edge information based on the first distance data, obtain first direction information of the electronic apparatus based on the first acceleration data; and obtain the first surface data based on the first edge information and the first direction information.

The second surface data may include second spatial information of the second surface and second object information of the second surface.

The at least one sensor further may include: a second distance sensor, the second sensor data may include second distance data obtained through the second distance sensor and second acceleration data obtained through the acceleration sensor, and the instructions, when executed by the at least one processor, may cause the electronic apparatus to: detect second edge information based on the second distance data, obtain second direction information of the electronic apparatus based on the second acceleration data, and obtain the second surface data based on the second edge information and the second direction information.

The at least one sensor further may include a vision sensor, the second sensor data may further include image data obtained through the vision sensor, and the instructions, when executed by the at least one processor, may cause the electronic apparatus to update the second object information based on the image data.

The at least one sensor further may include a tilt sensor, the second sensor data further may include tilt data obtained through the tilt sensor, and the instructions, when executed by the at least one processor, may cause the electronic apparatus to: obtain, based on the tilt data, a first tilt angle in a roll direction, a second tilt angle in a pitch direction, and a third tilt angle in a yaw direction, of the electronic apparatus, and update the second spatial information based on the first tilt angle, the second tilt angle, and the third tilt angle.

The first distance sensor may be a Light Detection and Ranging (LiDAR) sensor, the second distance sensor may be a Time of Flight (ToF) sensor, and the tilt sensor may be a gyro sensor.

The instructions, when executed by the at least one processor, may cause the electronic apparatus to: obtain, based on the first spatial information and the second spatial information corresponding to a same location, third spatial information by combining the first spatial information and the second spatial information, obtain, based on the first object information and the second object information corresponding to a same location, third object information by combining the first object information and the second object information, and obtain the map, wherein the map may include the third spatial information and the third object information.

According to an aspect of the disclosure, a controlling method of an electronic apparatus, includes: based on receiving a request for a map corresponding to a target space, obtaining first surface data for a first surface corresponding to a driving direction of the electronic apparatus based on first sensor data obtained in first driving for the target space; obtaining second surface data for a second surface different from the first surface based on second sensor data obtained in second driving for the target space; and obtaining the map based on the first surface data and the second surface data.

The first surface data may include first information corresponding to a horizontal surface including an x axis and a y axis based on the driving direction of the electronic apparatus, and the second surface data may include second information corresponding to a vertical surface including a z axis based on the driving direction of the electronic apparatus.

The first surface data may include first spatial information of the first surface and first object information of the first surface.

The electronic apparatus may include a first distance sensor and an acceleration sensor, the first sensor data may include first distance data obtained through the first distance sensor and first acceleration data obtained through the acceleration sensor, and the obtaining the first surface data may include: detecting first edge information based on the first distance data; obtaining first direction information of the electronic apparatus based on the first acceleration data; and obtaining the first surface data based on the first edge information and the first direction information.

The second surface data may include second spatial information of the second surface and second object information of the second surface.

### BRIEF DESCRIPTION OF THE DRAWINGS

The above and other aspects, features, and advantages of certain embodiments of the present disclosure are more apparent from the following description taken in conjunction with the accompanying drawings, in which:

FIG. 1 is a diagram for illustrating a map according to an embodiment;

FIG. 2 is a block diagram illustrating an electronic apparatus according to an embodiment;

FIG. 3 is a block diagram for illustrating a detailed configuration of the electronic apparatus in FIG. 2 according to an embodiment;

FIG. 4 is a diagram for illustrating an operation of obtaining horizontal surface data and vertical surface data through a sensor part according to an embodiment;

FIG. 5 is a diagram for illustrating an operation of obtaining horizontal surface data and vertical surface data through a sensor part according to an embodiment;

FIG. 6 is a diagram for illustrating an operation of generating a map according to an embodiment;

FIG. 7 is a diagram for illustrating an operation of generating a map based on a predetermined event according to an embodiment;

FIG. 8 is a diagram for illustrating an operation of generating a map based on spatial information and object information according to an embodiment;

FIG. 9 is a diagram for illustrating an operation of generating a map by merging distance data according to an embodiment;

FIG. 10 is a diagram for illustrating a horizontal tilt according to an embodiment;

FIG. 11 is a diagram for illustrating a vertical tilt according to an embodiment;

FIG. 12 is a diagram for illustrating horizontal warping according to an embodiment;

FIG. 13 is a diagram for illustrating rotation information of an electronic apparatus according to an embodiment;

FIG. 14 is a diagram for illustrating rotation information of a projection surface according to an embodiment;

FIG. 15 is a diagram for illustrating rotation information of a z axis of a projection surface according to an embodiment;

FIG. 16 is a diagram for illustrating rotation information of a y axis of a projection surface according to an embodiment;

FIG. 17 is a diagram for illustrating an operation of performing a keystone function in consideration of a vertical tilt according to an embodiment;

FIG. 18 is a diagram for illustrating an operation of performing a keystone function in consideration of a horizontal tilt according to an embodiment;

FIG. 19 is a diagram for illustrating a map of a horizontal surface, a map of a vertical surface, and a combined map according to an embodiment;

FIG. 20 is a diagram for illustrating a map according to an embodiment;

FIG. 21 is a diagram for illustrating an operation of generating a combined map by using a map of a horizontal surface and a map of a vertical surface according to an embodiment;

FIG. 22 is a diagram for illustrating an operation of obtaining a map through a server according to an embodiment;

FIG. 23 is a diagram for illustrating an operation of outputting a projection image according to an embodiment; and

FIG. 24 is a diagram for illustrating a controlling method of an electronic apparatus according to an embodiment.

### DETAILED DESCRIPTION

The embodiments described in the disclosure, and the configurations shown in the drawings, are only examples of embodiments, and various modifications may be made without departing from the scope and spirit of the disclosure.

Hereinafter, the disclosure will be described in detail with reference to the accompanying drawings.

As terms used in the embodiments of the disclosure, terms that are currently used widely were selected, in consideration of the functions described in the disclosure. However, the terms may vary depending on the intention of those skilled in the art who work in the pertinent field or previous court decisions, or emergence of new technologies, etc. There may be terms that were designated by the applicant on his own, and in such cases, the meaning of the terms will be described in detail in the relevant descriptions in the disclosure. Accordingly, the terms used in the disclosure should be defined based on the meaning of the terms and the overall content of the disclosure, but not just based on the names of the terms.

Expressions such as “have,” “may have,” “include,” and “may include” should be construed as denoting that there are such characteristics (e.g., elements such as numerical values, functions, operations, and components), and the terms are not intended to exclude the existence of additional characteristics.

In addition, the expression “at least one of A and/or B” should be interpreted to mean any one of “A” or “B” or “A and B.”

Further, the expressions “first,” “second,” and the like, may be used to describe various elements regardless of any order and/or degree of importance. Also, such expressions are used only to distinguish one element from another element, and are not intended to limit the elements.

The description in the disclosure that one element (e.g.: a first element) is “(operatively or communicatively) coupled with/to” or “connected to” another element (e.g.: a second element) should be interpreted to include both the case where the one element is directly coupled to the another element, and the case where the one element is coupled to the another element through still another element (e.g.: a third element).

Also, singular expressions include plural expressions, unless defined obviously differently in the context. Further, in the disclosure, terms such as “include” and “consist of” should be construed as designating that there are such characteristics, numbers, steps, operations, elements, components, or a combination thereof described, but not as excluding in advance the existence or possibility of adding one or more of other characteristics, numbers, steps, operations, elements, components, or a combination thereof.

Also, in the disclosure, “a module” or “a part” performs at least one function or operation, and may be implemented as hardware or software, or as a combination of hardware and software. In addition, a plurality of “modules” or “parts” may be integrated into at least one module and related operations may be performed by at least one processor.

The term “user” may refer to a person who uses an electronic apparatus or an apparatus using an electronic apparatus (e.g.: an artificial intelligence electronic apparatus).

Hereinafter, an embodiment of the disclosure will be described in more detail with reference to the accompanying drawings.

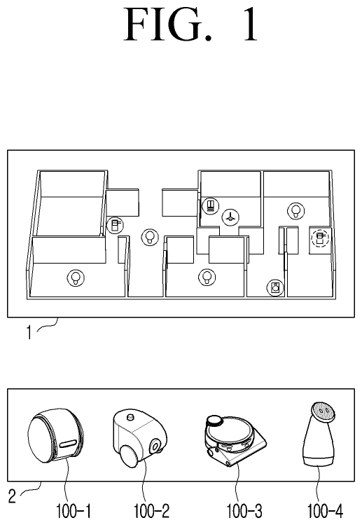

FIG. 1 is a diagram for illustrating a map according to an embodiment.

Referring to the embodiment 1 in FIG. 1, the electronic apparatus 100 may generate a map. The map may indicate a map for a space for the electronic apparatus 100 to move. The map may include information related to a three-dimensional space. The map may include information for driving of the electronic apparatus 100. The map may include spatial information and object information.

The spatial information may include coordinate information for the three-dimensional space.

The object information may include information related to an object existing in the three-dimensional space.

The electronic apparatus 100 may identify (or obtain) a driving route by using the map. The electronic apparatus 100 may identify information on an object existing in a space by using the map. The electronic apparatus 100 may identify a driving route in consideration of the object existing in the space.

In the aforementioned explanation and the explanation below, a three-dimensional map may be described as a map or a two-dimensional map.

Referring to the embodiment 2 in FIG. 1, the electronic apparatus 100 may be implemented as various apparatuses 100-1, 100-2, 100-3, 100-4.

The first apparatus 100-1 may be an apparatus that includes a projection part projecting images. The first apparatus 100-1 may be a projector.

The second apparatus 100-2 may be a projector that has a different external shape from the first apparatus 100-1.

The third apparatus 100-3 may be an apparatus that performs a cleaning function. The third apparatus 100-3 may be a robot cleaner.

The fourth apparatus 100-4 may be an apparatus that performs a service function. The fourth apparatus 100-4 may be a movable service robot. The service may include a service of providing information in an image or an audio form to a user.

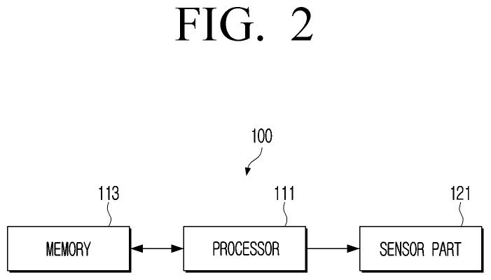

FIG. 2 is a block diagram illustrating the electronic apparatus 100 according to an embodiment.

Referring to FIG. 2, the electronic apparatus 100 may include memory 113, a sensor part 121, and at least one processor 111.

The memory 113 may store various types of sensor data obtained at the sensor part 121 and data obtained by the electronic apparatus 100 (data of a horizontal surface, data of a vertical surface, a three-dimensional map, etc.). The memory 113 may store various types of intermediate data used in the midway when the electronic apparatus 100 is obtaining a three-dimensional map.

The sensor part 121 may detect information regarding the space wherein the electronic apparatus 100 is arranged. The sensor part 121 may detect information related to the electronic apparatus 100. Various analyzing operations may be performed based on the sensor data collected by the sensor part 121.

The at least one processor 111 may be connected with the memory 113 and the sensor part 121, and perform various functions or instructions of the electronic apparatus 100.

When a request for a three-dimensional map corresponding to a target space is received, the at least one processor 111 may obtain first sensor data through the sensor part 121 in first driving for the target space.

The target space may indicate a space wherein the electronic apparatus 100 is driving. Also, the target space may indicate a space for generating a three-dimensional map. As an example, the target space may be identified according to driving of the electronic apparatus 100.

As an example, the target space may be determined by a user input.

A request for a three-dimensional map may indicate a request for generating a three-dimensional map. A request for a three-dimensional map may be determined according to occurrence of a predetermined event. When a predetermined event occurs, the at least one processor 111 may identify that a request for a three-dimensional map was received.

The predetermined event may include at least one of an event wherein a setting mode is executed after initial booting, an event wherein a predetermined user input is received, an event wherein a predetermined input is received from an external apparatus, or a notification event.

An event wherein the setting mode is executed after initial booting may indicate an event wherein the setting mode is executed in case power is supplied in a factory initialization state or a setting initialization state.

An event where a predetermined user input is received may indicate an event wherein a user input requesting a three-dimensional map is received. The user input may be received through a voice or a manipulation.

An event wherein a predetermined input is received from an external apparatus may indicate an event wherein an input requesting a three-dimensional map is received from an external apparatus.

A notification event may indicate an event wherein a predetermined notification is generated. The predetermined notification may be a notification that information related to a three-dimensional map is changed. For example, a notification event may include a notification that the location of an object existing in a space is changed.

If a request for a three-dimensional map corresponding to the target space is received, the at least one processor 111 may perform the first driving for analyzing the target space. The electronic apparatus 100 may include a moving element 122. The at least one processor 111 may perform a driving function by controlling the moving element 122. The at least one processor 111 may perform analysis for the target space through the first driving.

The at least one processor 111 may obtain horizontal surface data (the first data) for a horizontal surface (the first surface) in parallel to the driving direction of the electronic apparatus 100 based on the first sensor data. The horizontal surface data may be described as the first data or data for the first surface.

The horizontal surface in parallel to the driving direction of the electronic apparatus 100 may mean an xy plane in the three-dimensional space wherein the electronic apparatus 100 exists.

The horizontal surface data may include information related to the horizontal surface. The horizontal surface data may include at least one of spatial information or object information of the horizontal surface. The horizontal surface data may be data indicating information on a two-dimensional plane.

The at least one processor 111 may determine whether all of the horizontal surface data was obtained for the entire target space. The at least one processor 111 may determine whether collection of the horizontal surface data was all completed for the target space. The driving of the electronic apparatus 100 for collecting the completed horizontal surface data may be described as the first driving.

When the first driving is completed, the at least one processor 111 may start new driving (the second driving) for obtaining vertical surface data (data for the second surface).

The first surface and the second surface may be perpendicular to each other. The vertical surface data may be described as the second data or the data for the second surface.

According to various embodiments, the at least one processor 111 may identify a driving route used in the second driving based on the horizontal surface data obtained by the first driving. The at least one processor 111 may collect the vertical surface data by using the horizontal surface data obtained by the first driving. The at least one processor 111 may not randomly collect information on the vertical surface (the second surface), but collect information on the vertical surface based on the information on the horizontal surface that was already obtained. For example, the at least one processor 111 may obtain z axis information corresponding to the structure of the horizontal surface as the vertical surface data based on the structure of the horizontal surface.

When the horizontal surface data is obtained, the at least one processor 111 may obtain the second sensor data through the sensor part 121 in the second driving for the target space.

The horizontal surface data may include only information on the xy plane regarding the driving direction of the electronic apparatus 100. Accordingly, the horizontal surface data may include only two-dimensional information. The at least one processor 111 may additionally obtain z plane information (or z axis information) not included in the horizontal surface data. The at least one processor 111 may obtain the second sensor data through the second driving. The second driving may be performed after the first driving is completed.

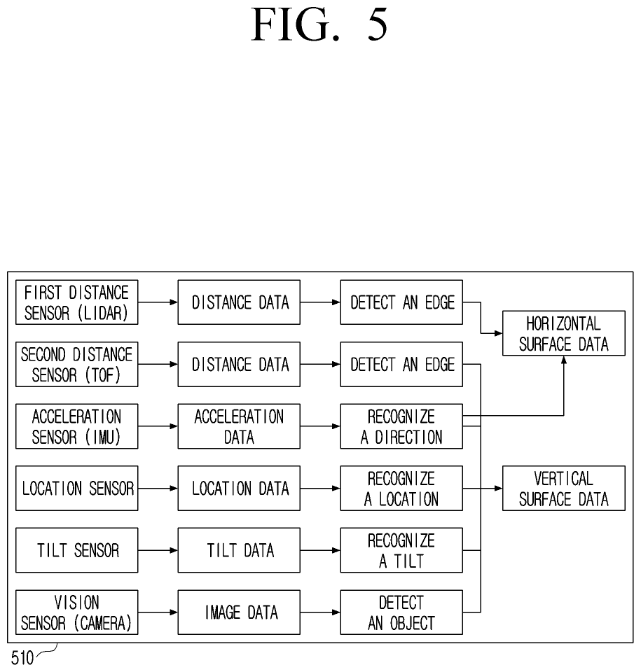

According to various embodiments, the horizontal surface data and the vertical surface data may be obtained together with one driving. An embodiment related to this will be described in FIG. 5. The embodiment in FIG. 5 discloses an operation wherein the horizontal surface data and the vertical surface data are obtained simultaneously, and other operations may overlap with other embodiments.

The at least one processor 111 may obtain the vertical surface data regarding the vertical surface perpendicular to the horizontal surface based on the second sensor data.

The vertical surface may mean a plane that is perpendicular based on the horizontal surface. The vertical surface may indicate a plane that is perpendicular to the xy plane corresponding to the driving direction of the electronic apparatus 100.

The vertical surface data may include information related to the vertical surface. The vertical surface data may include at least one of the spatial information of the vertical surface or the object information of the vertical surface.

As an example, the vertical surface data may include height information (the z axis information) of the space or height information (the z axis information) of the object.

As an example, the vertical surface data may include information on a plane that is perpendicular to a plane corresponding to the horizontal surface data.

The at least one processor 111 may determine whether all of the vertical surface data was obtained for the entire target space. The at least one processor 111 may determine whether collection of the vertical surface data was all completed for the target space. The driving of the electronic apparatus 100 for collecting the completed vertical surface data may be described as the second driving.

When the second driving is completed, the at least one processor 111 may obtain a three-dimensional map for the target space. The at least one processor 111 may obtain a three-dimensional map based on the horizontal surface data obtained through the first driving and the vertical surface data obtained through the second driving.

The at least one processor 111 may obtain a three-dimensional map wherein the horizontal surface data and the vertical surface data are combined. The three-dimensional map may be generated by combination of the horizontal surface data and the vertical surface data.

The at least one processor 111 may obtain information on a three-dimensional space by combining the horizontal surface data and the vertical surface data based on location information (or coordinate information) for the same target space. The horizontal surface data may include information on the xy plane based on the driving direction of the electronic apparatus 100, and the vertical surface data may include information on the z axis based on the driving direction of the electronic apparatus 100. In the case of combining the horizontal surface data and the vertical surface data, a three-dimensional map indicating information on the three-dimensional target space may be generated.

As an example, the at least one processor 111 may generate a three-dimensional map by combining the horizontal surface data and the vertical surface data by itself.

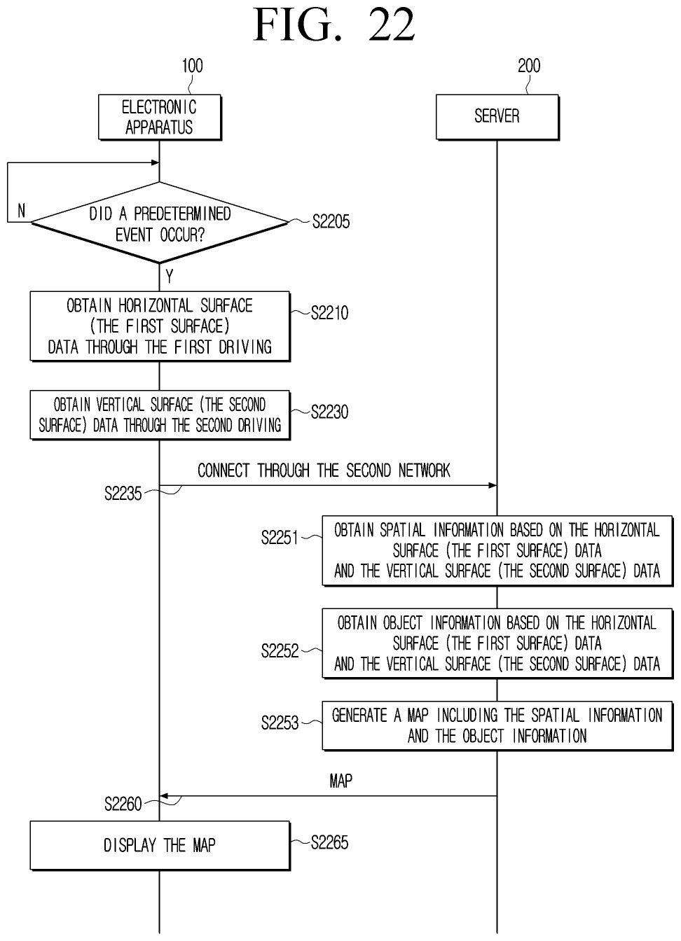

As an example, the at least one processor 111 may transmit the horizontal surface data and the vertical surface data to the server 200, and receive a three-dimensional map through the server 200. Additional explanation in this regard will be described in FIG. 22.

The horizontal surface data may include information on the horizontal surface including an x axis and a y axis based on the driving information of the electronic apparatus 100.

The horizontal surface in parallel to the driving direction of the electronic apparatus 100 may mean the xy plane in the three-dimensional space wherein the electronic apparatus 100 exists.

The vertical surface data may include information on the vertical surface including a z axis based on the driving direction of the electronic apparatus 100.

The vertical surface data may include information on the vertical surface that is perpendicular to the horizontal surface based on the driving direction of the electronic apparatus 100.

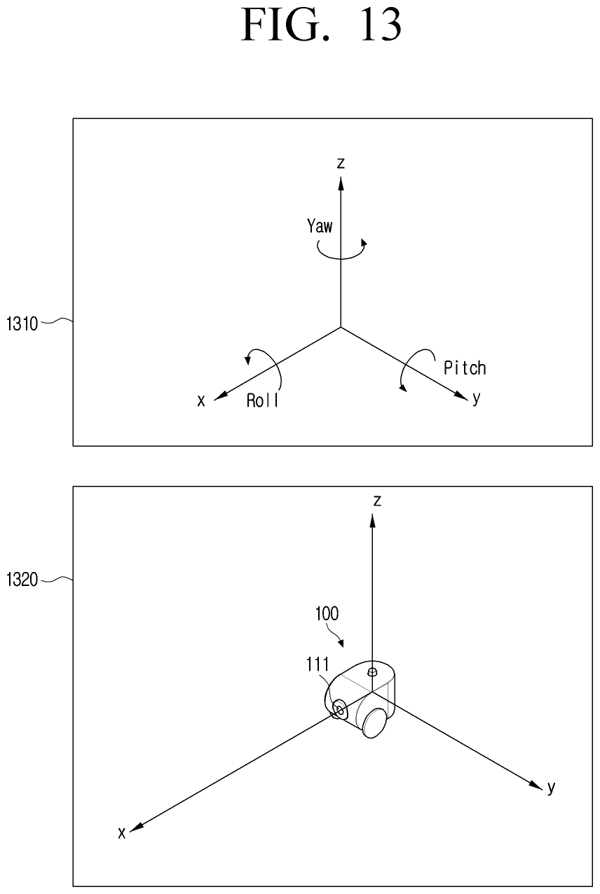

Explanation regarding the x axis, the y axis, the z axis, and the xy plane, etc. will be described in FIG. 13.

The at least one processor 111 may obtain the horizontal surface data including the first spatial information of the horizontal surface and the first object information of the horizontal surface based on the first sensor data.

The first sensor data may include at least one data obtained through the first driving. The at least one processor 111 may obtain the first spatial information and the first object information by analyzing the first sensor data. The first spatial information and the first object information may be information obtained based on the xy plane.

The first spatial information may be information indicating the spatial structure regarding the xy plane of the target space. The first object information may be information indicating the object existing on the xy plane of the target space.

The sensor part 121 may include the first distance sensor and the acceleration sensor. The first sensor data may include the first distance data obtained through the first distance sensor and the first acceleration data obtained through the acceleration sensor.

The at least one processor 111 may detect the first edge information based on the first distance data. The first edge information may indicate information on edge(s) of the xy plane identified in the target space. The first edge information may include the shape of the edge and the location of the edge of the xy plane. As the term covering the shape of the edge and the location of the edge, the structure of the edge may be described.

The at least one processor 111 may detect an edge through the first distance sensor. The at least one processor 111 may obtain a distance between the electronic apparatus 100 and the detected edge based on the first distance data obtained through the first distance sensor. The at least one processor 111 may obtain the location (the relative location) of the edge. The at least one processor 111 may include the first edge information including the shape of the edge and the location of the edge by summing up the plurality of distance data.

The at least one processor 111 may obtain the first direction information of the electronic apparatus 100 based on the first acceleration data. The at least one processor 111 may obtain information on the moving and the direction of the at least one processor 111 based on the first acceleration data obtained through the acceleration sensor. The at least one processor 111 may identify in which direction the electronic apparatus 100 moves based on the acceleration data. The at least one processor 111 may identify at what speed the electronic apparatus 100 is moving based on the acceleration data.

The at least one processor 111 may identify the location of the electronic apparatus 100 by analyzing the acceleration data indicating the moving and the direction of the electronic apparatus 100. The at least one processor 111 may identify in which location the electronic apparatus 100 exists in the target space based on the acceleration data. The direction information may be described as the location information.

The at least one processor 111 may obtain the horizontal surface data including the first spatial information and the first object information based on the first edge information and the first direction information.

The first edge information may indicate the relative locations of the edges detected based on the first distance data. The first direction information may indicate the location wherein the first distance data was detected in the target space. The at least one processor 111 may specify the absolute locations of the edges in the target space by using both of the first edge information and the first direction information.

The at least one processor 111 may analyze the shapes of the detected edges, and determine whether the edges indicate a space or indicate an object. An edge indicating a space may be in a rectilinear form. The length of an edge indicating a space may exceed a first threshold value. The length of an edge indicating an object may be smaller than a second threshold value. The first threshold value may be bigger than the second threshold value.

The shape of an edge indicating an object may be stored in advance. If the shape of an edge is a predetermined shape, the at least one processor 111 may identify that the edge corresponds to an object.

The at least one processor 111 may obtain at least one of the first spatial information or the first object information based on the first distance data and the acceleration data obtained on the same time point. The at least one processor 111 may obtain the first distance data on the first time point, and obtain the first acceleration data on the first time point. The at least one processor 111 may determine the first sensor location of the electronic apparatus 100 based on the first acceleration data. The at least one processor 111 may identify the location of an edge based on the first distance data obtained in the first sensor location.

The at least one processor 111 may obtain the first spatial information and the first object information by analyzing the locations of the edges obtained in the plurality of sensor locations. The plurality of sensor locations may be included in the target space.

The at least one processor 111 may identify the vertical surface data including the second spatial information of the vertical surface and the second object information of the vertical surface based on the second sensor data.

The second sensor data may include at least one data obtained through the second driving. The at least one processor 111 may analyze the second sensor data, and obtain the second spatial information and the second object information. The second spatial information and the second object information may be information obtained based on the z axis.

The second spatial information may be information indicating the spatial structure for the z axis of the target space. The second object information may be information indicating the object existing on the z axis of the target space.

The sensor part 121 may include the second distance sensor and the acceleration sensor. The second sensor data may include the second distance data obtained through the second distance sensor and the second acceleration data obtained through the acceleration sensor.

The at least one processor 111 may detect the second edge information based on the second distance data.

The second edge information may indicate information on edge(s) of the z axis identified in the target space. The second edge information may include the shape of the edge and the location of the edge of the z axis. As the term covering the shape of the edge and the location of the edge, the structure of the edge may be described.

The at least one processor 111 may detect an edge through the second distance sensor. The at least one processor 111 may obtain a distance between the electronic apparatus 100 and the detected edge based on the second distance data obtained through the second distance sensor. The at least one processor 111 may obtain the location (the relative location) of the edge. The at least one processor 111 may include the second edge information including the shape of the edge and the location of the edge by summing up the plurality of distance data.

The at least one processor 111 may obtain the second direction information of the electronic apparatus 100 based on the second acceleration data. The at least one processor 111 may obtain information on the moving and the direction of the at least one processor 111 based on the second acceleration data obtained through the acceleration sensor. The at least one processor 111 may identify the location of the electronic apparatus 100 by analyzing the acceleration data indicating the moving and the direction of the electronic apparatus 100.

The at least one processor 111 may obtain the vertical surface data including the second spatial information and the second object information based on the second edge information and the second direction information.

The second edge information may indicate the relative locations of the edges detected based on the second distance data. The second direction information may indicate the location wherein the second distance data was detected in the target space. The at least one processor 111 may specify the absolute locations of the edges in the target space by using both of the second edge information and the second direction information.

The at least one processor 111 may analyze the shapes of the detected edges, and determine whether the edges indicate a space or indicate an object. An edge indicating a space may be in a rectilinear form. The length of an edge indicating a space may exceed a third threshold value. The length of an edge indicating an object may be smaller than a fourth threshold value. The third threshold value may be bigger than the fourth threshold value.

The shape of an edge indicating an object may be stored in advance. If the shape of an edge is a predetermined shape, the at least one processor 111 may identify that the edge corresponds to an object.

The at least one processor 111 may obtain at least one of the second spatial information or the second object information based on the second distance data and the acceleration data obtained on the same time point. The at least one processor 111 may obtain the second distance data on the third time point, and obtain the second acceleration data on the third time point. The at least one processor 111 may determine the second sensor location of the electronic apparatus 100 based on the second acceleration data. The at least one processor 111 may identify the location of an edge based on the second distance data obtained in the second sensor location.

The at least one processor 111 may obtain the second spatial information and the second object information by analyzing the locations of the edges obtained in the plurality of sensor locations. The plurality of sensor locations may be included in the target space.

The sensor part 121 may include a vision sensor. The vison sensor may include a camera. The second sensor data may include the second distance data, the second acceleration data, and image data obtained through the vision sensor.

The at least one processor 111 may update the second object information based on the image data. The at least one processor 111 may identify an object by analyzing the image data. The at least one processor 111 may identify the type of the object and the location of the object by analyzing the image data.

In the case of analyzing an object only with edges detected through the distance sensor, the precision may relatively deteriorate. The at least one processor 111 may improve the precision of object analysis through the vision sensor. The at least one processor 111 may analyze the image data, and identify at least one of the type of the object or the location of the object.

The at least one processor 111 may update the second object information obtained based on the second distance data and the second acceleration data by analyzing the image data. As a result of the update, the precision of the second object information can be improved.

The sensor part 121 may include a tilt sensor. The second sensor data may include the second distance data, the second acceleration data, and tilt data obtained through the tilt sensor.

The at least one processor 111 may obtain a first tilt angle in a roll direction, a second tilt angle in a pitch direction, and a third tilt angle in a yaw direction of the electronic apparatus 100 based on the tilt data. Explanation regarding the roll direction, the pitch direction, and the yaw direction will be described in FIG. 13.

The at least one processor 111 may update the second spatial information based on the first tilt angle, the second tilt angle, and the third tilt angle.

The at least one processor 111 may identify the posture (or the posture information) of the electronic apparatus 100 based on the tilt data obtained through the tilt sensor. For example, the at least one processor 111 may determine at which tilting degree of the electronic apparatus 100 the sensor data was obtained based on the tilt data.

The at least one processor 111 may update the second spatial information based on the tilt data. The at least one processor 111 may correct a sensor error of the second sensor data by analyzing the tilt data. The sensor error may be an error that is generated by a tilted state of the electronic apparatus 100.

As an example, the first distance sensor may be a Light Detection and Ranging (LiDAR) sensor.

As an example, the second distance sensor may be a Time of Flight (ToF) sensor.

As an example, the tilt sensor may be a gyro sensor.

The at least one processor 111 may obtain the third spatial information by combining the first spatial information and the second spatial information based on the same location. The at least one processor 111 may obtain the third object information by combining the first object information and the second object information based on the same location. The at least one processor 111 may obtain a three-dimensional map including the third spatial information and the third object information.

The at least one processor 111 may obtain a three-dimensional map which is one integrated data by merging the first sensor data and the second sensor data. The standard for merging may be the same location. For example, the horizontal surface data corresponding to the first location of the target space and the vertical surface data corresponding to the first location of the target space may be merged.

According to various embodiments, the acceleration sensor may be replaced by the location sensor, and the acceleration data may be replaced by the location data, and the direction information may be replaced by the location information.

According to various embodiments, object information may be excluded with respect to a three-dimensional map.

In the aforementioned explanation, it was described that the first spatial information and the first object information are obtained in the first sensor data, and the second spatial information and the second object information are obtained in the second sensor data. According to various embodiments, the spatial information and the object information may not be respectively obtained in each sensor data. The electronic apparatus 100 may obtain one spatial information and one object information by merging the first sensor data and the second sensor data.

The electronic apparatus 100 obtains the horizontal surface data first, and then obtains the vertical surface data. In the case of randomly collecting the horizontal surface data and the vertical surface data, the processing time may take long for generating a three-dimensional map. In the case of obtaining the horizontal surface data first, and then obtaining the vertical surface data based on the horizontal surface data, the structure or the processing algorithm is simplified, and thus the processing time may be shortened.

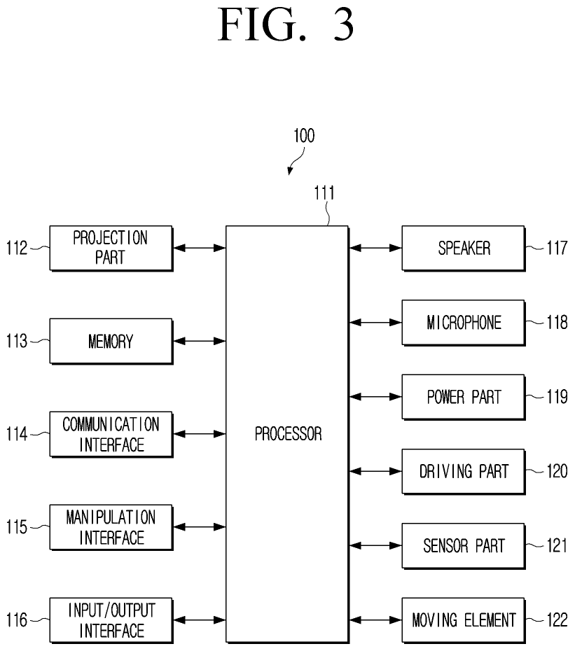

FIG. 3 is a block diagram for illustrating a detailed configuration of the electronic apparatus 100 in FIG. 2 according to an embodiment.

Referring to FIG. 3, the electronic apparatus 100 may include at least one of at least one processor 111, a projection part 112, memory 113, a communication interface 114, a manipulation interface 115, an input/output interface 116, a speaker 117, a microphone 118, a power part 119, a driving part 120, a sensor part 121, or a moving element 122.

The components illustrated in FIG. 3 are merely one of various examples, and some components may be added.

The at least one processor 111 may be implemented as a digital signal processor (DSP) processing digital signals, a microprocessor, and a time controller (TCON). However, the disclosure is not limited thereto, and the at least one processor 111 may include one or more of a central processing unit (CPU), a micro controller unit (MCU), a micro processing unit (MPU), a controller, an application processor (AP), a graphics-processing unit (GPU) or a communication processor (CP), and an advanced reduced instruction set computer (RISC) machines (ARM) processor, or may be defined by the terms. Also, the at least one processor 111 may be implemented as a system on chip (SoC) having a processing algorithm stored therein or large scale integration (LSI), or implemented in the form of a field programmable gate array (FPGA). The at least one processor 111 may perform various functions by executing computer executable instructions stored in the memory 113.

The projection part 112 is a component that projects an image to the outside. The projection part 112 according to the various embodiments of the disclosure may be implemented by various projection methods (e.g., a cathode-ray tube (CRT) method, a liquid crystal display (LCD) method, a digital light processing (DLP) method, a laser method, etc.). As an example, the CRT method has similar principles as a CRT monitor. In the CRT method, an image is enlarged to a lens in front of a cathode-ray tube (CRT), and the image is displayed on a screen. According to the number of cathode-ray tubes, the CRT method is divided into a one-tube method and a three-tube method, and in the case of the three-tube method, the method may be implemented while cathode-ray tubes of red, green, and blue colors are separated from one another.

As another example, the LCD method is a method of displaying an image by making a light output from a light source pass through a liquid crystal display. The LCD method is divided into a single-plate method and a three-plate method, and in the case of the three-plate method, a light output from a light source may be divided into red, green, and blue colors in a dichroic mirror (a mirror that reflects only lights of colors, and makes the rest pass through), and pass through a liquid crystal display, and then the lights may be gathered in one place.

As still another example, the DLP method is a method of displaying an image by using a digital micromirror device (DMD) chip. A projection part by the DLP method may include a light source, a color wheel, a DMD chip, a projection lens, etc. A light output from the light source may show a color as it passes through the rotating color wheel. The light that passed through the color wheel is input into the DMD chip. The DMD chip includes numerous micromirrors, and reflects the light input into the DMD chip. The projection lens may perform a role of enlarging the light reflected from the DMD chip to an image size.

As still another example, the laser method includes a diode pumped solid state (DPSS) laser and a galvanometer. As lasers outputting various colors, lasers wherein three DPSS lasers are installed for each of R, G, and B colors, and then their optical axes are overlapped by using a mirror. The galvanometer includes a mirror and a motor of a high output, and moves the mirror at a fast speed. For example, the galvanometer may rotate the mirror at 40 KHz/see at the maximum. The galvanometer is mounted according to a scanning direction, and a projector performs plane scanning, and thus the galvanometer may also be arranged while being divided into x and y axes.

The projection part 112 may include light sources in various types. For example, the projection part 112 may include at least one light source among a lamp, LEDs, or a laser.

The projection part 112 may output an image in a screen ratio of 4:3, a screen ratio of 5:4, and a wide screen ratio of 16:9 according to the use of the electronic apparatus 100 or the user's setting, etc., and output an image in various resolutions such as WVGA (854*480), SVGA (800*600), XGA (1024*768), WXGA (1280*720), WXGA (1280*800), SXGA (1280*1024), UXGA (1600*1200), Full HD (1920*1080), etc. according to screen ratios.

The projection part 112 may perform various functions for adjusting an output image by control by the at least one processor 111. For example, the projection part 112 may perform functions such as zoom, keystone, quick corner (four corner) keystone, lens shift, etc.

The projection part 112 may enlarge or reduce an image according to a distance from a screen (a projection distance). That is, a zoom function may be performed according to a distance from a screen. Here, the zoom function may include a hardware method of adjusting the size of the screen by moving the lens, and a software method of adjusting the size of the screen by a crop, etc. When the zoom function is performed, adjustment of a focus of an image may be performed. For example, methods of adjusting a focus include a manual focus method and an electric method, etc. The manual focus method means a method of adjusting a focus manually, and the electric method means a method wherein, when the zoom function is performed, the projector automatically adjusts a focus by using a built-in motor. When performing the zoom function, the projection part 112 may provide a digital zoom function through software, or provide an optical zoom function of performing a zoom function by moving the lens through the driving part 120.

The projection part 112 may perform a keystone correction function. A screen may be distorted in an upper direction or a lower direction if the height is not matched in front surface projection. The keystone correction function means a function of correcting a distorted screen. For example, if a distortion occurs in a left-right direction of a screen, the screen may be corrected by using horizontal keystone, and if a distortion occurs in an up-down direction, the screen may be corrected by using vertical keystone. The quick corner (four corner) keystone correction function is a function of correcting a screen in case the central area of the screen is normal, but the corner areas are out of balance. The lens shift function is a function of moving a screen as it is in case the screen is beyond the range of the screen.

The projection part 112 may perform the zoom/keystone/focus functions by automatically analyzing the ambient environment and the projection environment without a user input. The projection part 112 may automatically provide the zoom/keystone/focus functions based on the distance between the electronic apparatus 100 and the screen detected through the sensor (a depth camera, a distance sensor, an infrared sensor, an illumination sensor, etc.), information on the space wherein the electronic apparatus 100 is currently located, information on the ambient light amount, etc.

The projection part 112 may provide an illumination function by using a light source. The projection part 112 may provide an illumination function by outputting a light source by using LEDs. According to various embodiments, the projection part 112 may include one LED, and according to another embodiment, the electronic apparatus 100 may include a plurality of LEDs. The projection part 112 may output a light source by using a surface emitting LED depending on implementation examples. A surface emitting LED may mean an LED having a structure wherein an optical sheet is arranged on the upper side of the LED such that a light source is evenly dispersed and output. If a light source is output through an LED, the light source may be evenly dispersed through an optical sheet, and the light source dispersed through the optical sheet may be incident on a display panel.

The projection part 112 may provide a dimming function for adjusting the intensity of a light source to the user. If a user input for adjusting the intensity of a light source is received from the user through the manipulation interface 115 (e.g., a touch display button or a dial), the projection part 112 may control the LEDs to output the intensity of the light source corresponding to the received user input.

The projection part 112 may provide the dimming function based on a content analyzed by the at least one processor 111 without a user input. The projection part 112 may control the LEDs to output the intensity of a light source based on information on the currently provided content (e.g., the content type, the content brightness, etc.).

The projection part 112 may control the color temperature by control by the at least one processor 111. The at least one processor 111 may control the color temperature based on a content. If it is identified that a content is to be output, the at least one processor 111 may obtain the color information for each frame of the content of which output has been determined. Then, the at least one processor 111 may adjust the color temperature based on the obtained color information for each frame. The at least one processor 111 may obtain at least one main color of the frames based on the color information for each frame. Then, the at least one processor 111 may adjust the color temperature based on the obtained at least one main color. For example, the color temperature that can be adjusted by the at least one processor 111 may be divided into a warm type or a cold type. It is assumed that a frame to be output (referred to as an output frame hereinafter) includes a scene wherein fire broke out. The at least one processor 111 may identify (or obtain) that the main color is a red color based on the color information included in the current output frame. Then, the at least one processor 111 may identify a color temperature corresponding to the identified main color (red). The color temperature corresponding to the red color may be the warm type. The at least one processor 111 may use an artificial intelligence model for obtaining the color information or the main color of a frame. According to various embodiments, the artificial intelligence model may be stored in the electronic apparatus 100 (e.g., the memory 113). According to another embodiment, the artificial intelligence model may be stored in an external server that can communicate with the electronic apparatus 100.

The memory 113 may be implemented as internal memory such as ROM (e.g., electrically erasable programmable read-only memory (EEPROM)), RAM, etc., included in the at least one processor 111, or implemented as separate memory from the at least one processor 111. In this case, the memory 113 may be implemented in the form of memory embedded in the electronic apparatus 100, or implemented in the form of memory that can be attached to or detached from the electronic apparatus 100 according to the use of stored data. For example, in the case of data for driving the electronic apparatus 100, the data may be stored in memory embedded in the electronic apparatus 100, and in the case of data for an extended function of the electronic apparatus 100, the data may be stored in memory that can be attached to or detached from the electronic apparatus 100.

In the case of memory embedded in the electronic apparatus 100, the memory may be implemented as at least one of volatile memory (e.g.: dynamic RAM (DRAM), static RAM (SRAM), or synchronous dynamic RAM (SDRAM), etc.) or non-volatile memory (e.g.: one time programmable ROM (OTPROM), programmable ROM (PROM), erasable and programmable ROM (EPROM), electrically erasable and programmable ROM (EEPROM), mask ROM, flash ROM, flash memory (e.g.: NAND flash or NOR flash, etc.), a hard drive, or a solid state drive (SSD)). Also, in the case of memory that can be attached to or detached from the electronic apparatus 100, the memory may be implemented in forms such as a memory card (e.g., compact flash (CF), secure digital (SD), micro secure digital (Micro-SD), mini secure digital (Mini-SD), extreme digital (xD), a multi-media card (MMC), etc.), and external memory that can be connected to a USB port (e.g., a USB memory), etc.

In the memory 113, at least one instruction regarding the electronic apparatus 100 may be stored. Also, in the memory 113, an operating system (O/S) for operating the electronic apparatus 100 may be stored. In addition, in the memory 113, various kinds of software programs or applications for the electronic apparatus 100 to operate according to the various embodiments of the disclosure may be stored. Further, the memory 113 may include semiconductor memory such as flash memory, or a magnetic storage medium such as a hard disk, etc.

In the memory 113, various kinds of software modules for the electronic apparatus 100 to operate according to the various embodiments of the disclosure may be stored, and the at least one processor 111 may control the operations of the electronic apparatus 100 by executing the various kinds of software modules stored in the memory 113. That is, the memory 113 may be accessed by the at least one processor 111, and reading/recording/correction/deletion/update, etc. of data by the at least one processor 111 may be performed.

In the disclosure, the term memory 113 may be used as a meaning including the storage part, ROM and RAM inside the at least one processor 111, or a memory card (e.g., a micro SD card, a memory stick) installed on the electronic apparatus 100.

The communication interface 114 is a component that performs communication with various types of external apparatuses according to various types of communication methods. The communication interface 114 may include a wireless communication module or a wired communication module. Each communication module may be implemented in a form of at least one hardware chip.

A wireless communication module may be a module that communicates with an external apparatus wirelessly. For example, a wireless communication module may include at least one module among a Wi-Fi module, a Bluetooth module, an infrared communication module, or other communication modules.

A Wi-Fi module and a Bluetooth module may perform communication by a Wi-Fi method and a Bluetooth method, respectively. In the case of using a Wi-Fi module or a Bluetooth module, various types of connection information such as a service set identifier (SSID) and a session key is transmitted and received first, and connection of communication is performed by using the information, and various types of information can be transmitted and received thereafter.

An infrared communication module performs communication according to an infrared Data Association (IrDA) technology of transmitting data to a near field wirelessly by using infrared rays between visible rays and millimeter waves.

Other communication modules may include at least one communication chip that performs communication according to various wireless communication protocols such as Zigbee, 3rd Generation (3G), 3rd Generation Partnership Project (3GPP), Long Term Evolution (LTE), LTE Advanced (LTE-A), 4th Generation (4G), 5th Generation (5G), etc. other than the aforementioned communication methods.

A wired communication module may be a module that communicates with an external apparatus via wire. For example, a wired communication module may include at least one of a local area network (LAN) module, an Ethernet module, a pair cable, a coaxial cable, an optical fiber cable, or an ultra wide-band (UWB) module.

The manipulation interface 115 may include input devices in various types. For example, the manipulation interface 115 may include physical buttons. Here, the physical buttons may include function keys, direction keys (e.g., four direction keys), or dial buttons. According to various embodiments, the physical buttons may be implemented as a plurality of keys. According to another embodiment, the physical buttons may be implemented as one key. In case the physical buttons are implemented as one key, the electronic apparatus 100 may receive a user input by which the one key is pushed during a threshold time or longer. If a user input by which the one key is pushed during the threshold time or longer is received, the at least one processor 111 may perform a function corresponding to the user input. For example, the at least one processor 111 may provide an illumination function based on the user input.

The manipulation interface 115 may receive a user input by using a non-contact method. In the case of receiving a user input through a contact method, physical force should be transmitted to the electronic apparatus 100. Accordingly, a method for controlling the electronic apparatus 100 regardless of physical force may be used. The manipulation interface 115 may receive a user gesture, and perform an operation corresponding to the received user gesture. The manipulation interface 115 may receive a gesture of the user through a sensor (e.g., an image sensor or an infrared sensor).

The manipulation interface 115 may receive a user input by using a touch method. For example, the manipulation interface 115 may receive a user input through a touch sensor. According to various embodiments, the touch method may be implemented as a non-contact method. For example, the touch sensor may determine whether the user's body approached within a threshold distance. The touch sensor may identify a user input even when the user does not contact the touch sensor. According to another implementation example, the touch sensor may identify a user input by which the user contacts the touch sensor.

The electronic apparatus 100 may receive a user input by various methods other than the aforementioned manipulation interface 115. According to various embodiments, the electronic apparatus 100 may receive a user input through an external remote control apparatus. The external remote control apparatus may be a remote control apparatus corresponding to the electronic apparatus 100 (e.g., a dedicated control apparatus of the electronic apparatus 100) or the user's mobile communication apparatus (e.g., a smartphone or a wearable device). In the user's mobile communication apparatus, an application for controlling the electronic apparatus 100 may be stored. The mobile communication apparatus may obtain a user input through the stored application, and transmit the obtained user input to the electronic apparatus 100. The electronic apparatus 100 may receive the user input from the mobile communication apparatus, and perform an operation corresponding to the user's control command.

The electronic apparatus 100 may receive a user input by using voice recognition. According to various embodiments, the electronic apparatus 100 may receive a user voice through the microphone included in the electronic apparatus 100. According to another embodiment, the electronic apparatus 100 may receive a user voice from the microphone or an external apparatus. The external apparatus may obtain a user voice through a microphone of the external apparatus, and transmit the obtained user voice to the electronic apparatus 100. The user voice transmitted from the external apparatus may be audio data or digital data converted from audio data (e.g., audio data converted to a frequency domain, etc.). The electronic apparatus 100 may perform an operation corresponding to the received user voice. The electronic apparatus 100 may receive audio data corresponding to the user voice through the microphone. Then, the electronic apparatus 100 may convert the received audio data into digital data. Then, the electronic apparatus 100 may convert the converted digital data into text data by using a speech to text (STT) function. According to various embodiments, the speech to text (STT) function may be directly performed at the electronic apparatus 100.

According to another embodiment, the speech to text (STT) function may be performed at an external server. The electronic apparatus 100 may transmit digital data to the external server. The external server may convert the digital data into text data, and obtain control command data based on the converted text data. The external server may transmit the control command data (here, the text data may also be included) to the electronic apparatus 100. The electronic apparatus 100 may perform an operation corresponding to the user voice based on the obtained control command data.

The electronic apparatus 100 may provide a voice recognition function by using one assistance (or an artificial intelligence agent, e.g., Bixby™, etc.), but this is merely one of various examples, and the electronic apparatus 100 may provide the voice recognition function through a plurality of assistances. Here, the electronic apparatus 100 may provide the voice recognition function by selecting one of the plurality of assistances based on a trigger word corresponding to the assistance or a key existing on a remote control.

The electronic apparatus 100 may receive a user input by using a screen interaction. A screen interaction may mean a function by which the electronic apparatus 100 identifies whether a predetermined event occurs through an image projected on a screen (or a projection surface), and obtains a user input based on the predetermined event. The predetermined event may mean an event wherein a predetermined object is identified in a location (e.g., a location on which a UI for receiving a user input was projected). The predetermined object may include at least one of a part of the user's body (e.g., a finger), a pointer, or a laser point. When the predetermined object is identified in a location corresponding to the projected UI, the electronic apparatus 100 may identify that a user input selecting the projected UI was received. For example, the electronic apparatus 100 may project a guide image such that a UI is displayed on the screen. Then, the electronic apparatus 100 may identify whether the user selects the projected UI. If the predetermined object is identified in the location of the projected UI, the electronic apparatus 100 may identify that the user selected the projected UI. The projected UI may include at least one item. The electronic apparatus 100 may perform spatial analysis for identifying whether the predetermined object is in the location of the projected UI. The electronic apparatus 100 may perform spatial analysis by using a sensor (e.g., an image sensor, an infrared sensor, a depth camera, a distance sensor, etc.). The electronic apparatus 100 may identify whether the predetermined event occurs in a location (the location on which the UI was projected) by performing spatial analysis. Then, if it is identified that the predetermined event occurred in the location (the location on which the UI was projected), the electronic apparatus 100 may identify that a user input for selecting the UI corresponding to the location was received.

The input/output interface 116 is a component for inputting or outputting at least one of an audio signal or an image signal. The input/output interface 116 may receive input of at least one of an audio signal or an image signal from an external apparatus, and output a control command to the external apparatus.

Depending on implementation examples, the input/output interface 116 may be implemented as an interface inputting or outputting only audio signals and an interface inputting or outputting only image signals, or implemented as one interface inputting or outputting both audio signals and image signals.

The input/output interface 116 according to the various embodiments of the disclosure may be implemented as at least one wired input/output interface among a high definition multimedia interface (HDMI), a mobile high-definition link (MHL), a universal serial bus (USB), a USB C-type, a display port (DP), a Thunderbolt, a video graphics array (VGA) port, an RGB port, a D-subminiature (D-SUB), or a digital visual interface (DVI). According to various embodiments, the wired input/output interface may be implemented as an interface inputting or outputting only audio signals and an interface inputting or outputting only image signals, or implemented as one interface inputting or outputting both audio signals and image signals.

The electronic apparatus 100 may receive data through the wired input/output interface, but this is merely one of various examples, and the electronic apparatus 100 may be provided with power through the wired input/output interface. For example, the electronic apparatus 100 may be provided with power from an external battery through a USB C-type, or may be provided with power from a consent through a power adapter. As another example, the electronic apparatus 100 may be provided with power from an external apparatus (e.g., a laptop or a monitor, etc.) through a DP.

The electronic apparatus 100 may be implemented such that an audio signal is input through the wired input/output interface, and an image signal is input through the wireless input/output interface (or the communication interface). The electronic apparatus 100 may be implemented such that an audio signal is input through the wireless input/output interface (or the communication interface), and an image signal is input through the wired input/output interface.

The speaker 117 is a component that outputs audio signals. The speaker 117 may include an audio output mixer, an audio signal processor, and an audio output module. The audio output mixer may synthesize a plurality of audio signals to be output into at least one audio signal. For example, the audio output mixer may synthesize an analog audio signal and another analog audio signal (e.g.: an analog audio signal received from the outside) into at least one analog audio signal. The audio output module may include a speaker or an output terminal. According to various embodiments, the audio output module may include a plurality of speakers, and in this case, the audio output module may be arranged inside the main body, and audio that is emitted while covering at least a portion of the diaphragm may pass through a waveguide, and may be transmitted to the outside of the main body. The audio output module may include a plurality of audio output units, and as the plurality of audio output units are symmetrically arranged on the exterior of the main body, audio may be emitted in all directions, e.g., all directions in 360 degrees.

The microphone 118 is a component for receiving input of a user voice or other sounds, and converting them into audio data. The microphone 118 may receive a user's voice in an activated state. For example, the microphone 118 may be formed as an integrated type integrated to the upper side or the front surface direction, the side surface direction, etc. of the electronic apparatus 100. The microphone 118 may include various components such as a microphone collecting a user voice in an analog form, an amp circuit amplifying the collected user voice, an A/D conversion circuit that samples the amplified user voice and converts the user voice into a digital signal, a filter circuit that removes noise components from the converted digital signal, etc.

The power part 119 may be provided with power from the outside, and provide power to the various components of the electronic apparatus 100. The power part 119 according to the various embodiments of the disclosure may be provided with power through various methods. According to various embodiments, the power part 119 may be provided with power by using the connector 130 as illustrated in FIG. 1. The power part 119 may be provided with power by using a DC power code of 220V. However, the disclosure is not limited thereto, and the electronic apparatus 100 may be provided with power by using a USB power code or provided with power by using a wireless charging method.

The power part 119 may be provided with power by using an internal battery or an external battery. The power part 119 according to the various embodiments of the disclosure may be provided with power through the internal battery. As an example, the power part 119 may charge power of the internal battery by using at least one of a DC power cord of 220V, a USB power cord, or a USB C-Type power cord, and may be provided with power through the charged internal battery. Also, the power part 119 according to the various embodiments of the disclosure may be provided with power through the external battery. As an example, if connection between the electronic apparatus 100 and the external battery is performed through various wired communication methods such as the USB power code, the USB C-type power code, or a socket groove, etc., the power part 119 may be provided with power through the external battery. That is, the power part 119 may directly be provided with power from the external battery, or charge the internal battery through the external battery and be provided with power from the charged internal battery.

The power part 119 according to the disclosure may be provided with power by using at least one of the aforementioned plurality of power supply methods.

With respect to power consumption, the electronic apparatus 100 may have power consumption of a predetermined value (e.g., 43 W) or less due to the socket type, other standards, etc. Here, the electronic apparatus 100 may vary power consumption to reduce the power consumption when using the battery. That is, the electronic apparatus 100 may vary power consumption based on the power supply method, the power usage amount, or the like.

The driving part 120 may drive at least one hardware component included in the electronic apparatus 100. The driving part 120 may generate physical force, and transmit the force to at least one hardware component included in the electronic apparatus 100.

The driving part 120 may generate driving power for a moving operation of a hardware component included in the electronic apparatus 100 (e.g., moving of the electronic apparatus 100) or a rotating operation of a component (e.g., rotation of the projection lens).

The driving part 120 may adjust a projection direction of the projection part 112. Also, the driving part 120 may move the location of the electronic apparatus 100. The driving part 120 may control the moving element for moving the electronic apparatus 100. For example, the driving part 120 may control the moving element by using the motor.

The sensor part 121 may include at least one sensor. The sensor part 121 may include at least one of a tilt senor that detects the tilt of the electronic apparatus 100 or an image sensor that captures an image. The tilt sensor may be an acceleration sensor or a gyro sensor, and the image sensor may mean a camera or a depth camera. The tilt sensor may also be described as a motion sensor. The sensor part 121 may include various sensors other than a tilt sensor or an image sensor. For example, the sensor part 121 may include an illumination sensor or a distance sensor. The distance sensor may be a Time of Flight (ToF) sensor. Also, the sensor part 121 may include a LiDAR sensor.

The electronic apparatus 100 may control the illumination function by being interlocked with an external apparatus. The electronic apparatus 100 may receive illumination information from an external apparatus. The illumination information may include at least one of brightness information or color temperature information set in the external apparatus. The external apparatus may mean an apparatus connected to the same network as the electronic apparatus 100 (e.g., an IoT apparatus included in the same home/company network) or an apparatus that is not connected to the same network as the electronic apparatus 100 but can communicate with the electronic apparatus 100 (e.g., a remote control server). For example, it is assumed that an external illumination apparatus (an IoT apparatus) included in the same network as the electronic apparatus 100 is outputting a red lighting at the brightness of 50. The external illumination apparatus (an IoT apparatus) may directly or indirectly transmit illumination information (e.g., information that the red lighting is being output at the brightness of 50) to the electronic apparatus 100. The electronic apparatus 100 may control an output of a light source based on the illumination information received from the external illumination apparatus. For example, if the illumination information received from the external illumination apparatus includes information that the red lighting is being output at the brightness of 50, the electronic apparatus 100 may output the red lighting at the brightness of 50.

The electronic apparatus 100 may control the illumination function based on biometric information. The at least one processor 111 may obtain the biometric information of the user. The biometric information may include at least one of the body temperature, the heart rate, the blood pressure, the breathing, or the electrocardiogram of the user. The biometric information may include various kinds of information other than the aforementioned information. As an example, the electronic apparatus 100 may include a sensor for measuring biometric information. The at least one processor 111 may obtain the biometric information of the user through the sensor, and control an output of a light source based on the obtained biometric information. As another example, the at least one processor 111 may receive biometric information from an external apparatus through the input/output interface 116. The external apparatus may mean a portable communication apparatus (e.g., a smartphone or a wearable device) of the user. The at least one processor 111 may obtain the biometric information of the user from the external apparatus, and control an output of a light source based on the obtained biometric information. Depending on implementation examples, the electronic apparatus 100 may identify whether the user is sleeping, and if it is identified that the user is sleeping (or is preparing to sleep), the at least one processor 111 may control an output of a light source based on the biometric information of the user.

The electronic apparatus 100 according to the various embodiments of the disclosure may provide various smart functions.

The electronic apparatus 100 may be connected with a portable terminal apparatus for controlling the electronic apparatus 100, and the screen output from the electronic apparatus 100 may be controlled through a user input that is input into the portable terminal apparatus. As an example, the portable terminal apparatus may be implemented as a smartphone including a touch display, and the electronic apparatus 100 may receive screen data provided at the portable terminal apparatus from the portable terminal apparatus and output the screen, and the screen output from the electronic apparatus 100 may be controlled according to a user input that is input into the portable terminal apparatus.

The electronic apparatus 100 may perform connection with a portable terminal apparatus through various communication methods such as Miracast, Airplay, wireless DEX, a remote PC method, etc., and share contents or music provided at the portable terminal apparatus.

Also, connection between a portable terminal apparatus and the electronic apparatus 100 may be performed by various connection methods. According to various embodiments, a portable terminal apparatus may search the electronic apparatus 100 and perform wireless connection, or the electronic apparatus 100 may search the portable terminal apparatus and perform wireless connection. Then, the electronic apparatus 100 may output contents provided at the portable terminal apparatus.

According to various embodiments, while content or music is being output at a portable terminal apparatus, if the portable terminal apparatus is located near the electronic apparatus 100, and then a predetermined gesture (e.g., a motion tap view) is detected through the display of the portable terminal apparatus, the electronic apparatus 100 may output the content or the music that is being output at the portable terminal apparatus.

According to various embodiments, while content or music is being output at a portable terminal apparatus, if the portable terminal apparatus becomes close to the electronic apparatus 100 within a predetermined distance or shorter (e.g., a non-contact tap view), or the portable terminal apparatus contact the electronic apparatus 100 at a short interval twice (e.g., a contact tap view), the electronic apparatus 100 may output the content or the music that is being output at the portable terminal apparatus.

In the aforementioned embodiments, it was explained that the same screen as the screen that is being provided at a portable terminal apparatus is provided at the electronic apparatus 100, but the disclosure is not limited thereto. That is, if connection between a portable terminal apparatus and the electronic apparatus 100 is constructed, a first screen provided at the portable terminal apparatus may be output at the portable terminal apparatus, and a second screen provided at the portable terminal apparatus different from the first screen may be output at the electronic apparatus 100. As an example, the first screen may be a screen provided by a first application installed in the portable terminal apparatus, and the second screen may be a screen provided by a second application installed in the portable terminal apparatus. As an example, the first screen and the second screen may be different screens provided by one application installed in the portable terminal apparatus. As an example, the first screen may be a screen including a UI in a remote control format for controlling the second screen.

The electronic apparatus 100 according to the disclosure may output a standby screen. As an example, in case connection of the electronic apparatus 100 with an external apparatus was not performed or there is no input received from the external apparatus during a predetermined time, the electronic apparatus 100 may output a standby screen. Conditions for the electronic apparatus 100 to output a standby screen are not limited to the aforementioned example, and a standby screen may be output by various conditions.

The electronic apparatus 100 may output a standby screen in a form of a blue screen, but the disclosure is not limited thereto. As an example, the electronic apparatus 100 may extract only a form of an object from data received from an external apparatus and obtain an amorphous object, and output a standby screen including the obtained amorphous object.

The electronic apparatus 100 may further include a display.

The display may be implemented as displays in various forms such as a liquid crystal display (LCD), an organic light emitting diodes (OLED) display, a plasma display panel (PDP), etc. Inside the display, driving circuits that may be implemented in forms such as an amorphous silicon thin film transistor (a-si TFT), a low temperature poly silicon (LTPS) TFT, an organic TFT (OTFT), etc., and a backlight unit, etc. may also be included. The display may be implemented as a touch screen combined with a touch sensor, a flexible display, a three-dimensional (3D) display, etc. The display according to the various embodiments of the disclosure may include not only a display panel outputting images, but also a bezel housing the display panel. A bezel according to the various embodiments of the disclosure may include a touch sensor for detecting user interactions.

The electronic apparatus 100 may further include a shutter part.

The shutter part may include at least one of a shutter, a fixing element, a rail, or a body.

The shutter may block light output from the projection part 112. The fixing element may fix the location of the shutter. The rail may be a route through which the shutter and the fixing element are moved. The body may be a component including the shutter and the fixing element.

The moving element 122 may mean an element for the electronic apparatus 100 to move from the first location to the second location in the space wherein the electronic apparatus 100 is arranged. The electronic apparatus 100 may control the moving element 122 such that the electronic apparatus 100 is moved by using the force generated in the driving part 120. The electronic apparatus 100 may generate a force to be transmitted to the moving element 122 by using the motor included in the driving part 120.

The moving element 122 may include at least one wheel (e.g., a circular wheel). The electronic apparatus 100 may move to a target location (or an aimed location) through the moving element. If a user input or a control command is received, the electronic apparatus 100 may rotate the moving element 122 by transmitting the force generated through the motor to the moving element. The electronic apparatus 100 may control the moving element 122 for adjusting the rotation speed, the rotation direction, etc. The electronic apparatus 100 may perform a moving operation (or a moving function) by controlling the moving element 122 based on the target location or the proceeding direction, etc.

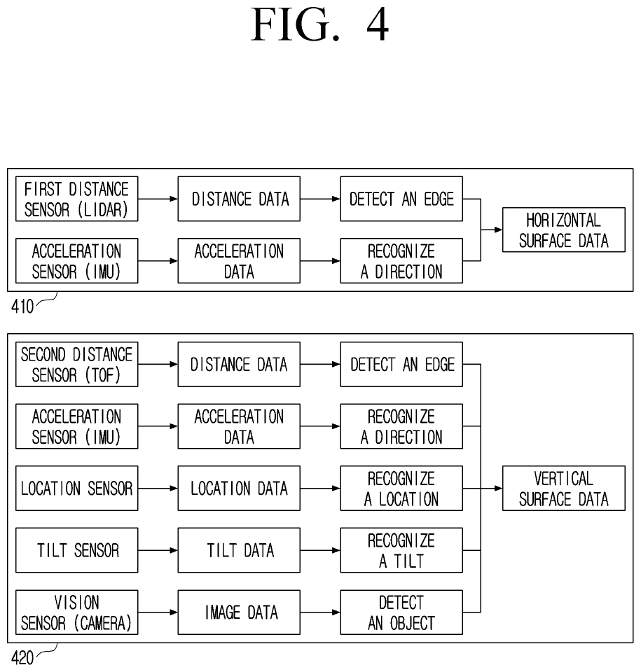

FIG. 4 is a diagram for illustrating an operation of obtaining horizontal surface data and vertical surface data through the sensor part 121 according to an embodiment.

Referring to FIG. 4, the sensor part 121 may include at least one of a first distance sensor, an acceleration sensor, a gyro sensor, a second distance sensor, a location sensor, a tilt sensor, or a vision sensor.

Referring to the embodiment 410 in FIG. 4, the sensor part 121 may include the first distance sensor and the acceleration sensor.

The electronic apparatus 100 may obtain distance data through the first distance sensor. The electronic apparatus 100 may detect an edge based on the distance data. The electronic apparatus 100 may obtain the distance between the electronic apparatus 100 and the edge based on the distance data. The distance between the electronic apparatus 100 and the edge may be described as the distance between the first distance sensor and the edge.

As an example, the first distance sensor may be a LiDAR sensor.

The electronic apparatus 100 may obtain acceleration data through the acceleration sensor. The electronic apparatus 100 may recognize a direction based on the acceleration data.

The feature of recognizing a direction may indicate recognizing in which direction the electronic apparatus 100 is arranged. For example, the electronic apparatus 100 may identify that the electronic apparatus 100 is arranged toward the first location by using the acceleration data.

As an example, the acceleration sensor may be implemented as an inertial measurement unit (IMU).

According to various embodiments, the electronic apparatus 100 may recognize a direction by using the gyro sensor instead of the acceleration sensor. The electronic apparatus 100 may obtain gyro data through the gyro sensor. The electronic apparatus 100 may recognize a direction based on the gyro data.

The electronic apparatus 100 may obtain horizontal surface data based on at least one of an edge or a direction. The horizontal surface may indicate a plane that is perpendicular to the z axis direction (refer to FIG. 13) based on the driving direction of the electronic apparatus 100. The electronic apparatus 100 may obtain at least one of the distance between the electronic apparatus 100 and the edge or the location (direction) of the electronic apparatus 100 that recognized the edge. The electronic apparatus 100 may obtain (or identify or generate) horizontal surface data of a space based on at least one of the obtained distance or location (direction).

The horizontal surface data may include the structure of a horizontal surface of a space (or a target space). The structure of the horizontal surface may include a spatial structure for at least one area.

Referring to the embodiment 420 in FIG. 4, the sensor part 121 may include at least one of the second distance sensor, the acceleration sensor, the location sensor, the tilt sensor, or the vision sensor.

The second distance sensor may correspond to the first distance sensor of the embodiment 410. According to various embodiments, the second distance sensor may be implemented as a Time of Flight (ToF) sensor.

The acceleration sensor may correspond to the acceleration sensor of the embodiment 420.

The location sensor may collect data for identifying the location of the electronic apparatus 100. The electronic apparatus 100 may obtain location data through the location sensor. The location sensor may be implemented as a sensor that transmits and/or receives a beacon signal, a GPS sensor, a LiDAR sensor, etc.

According to various embodiments, the electronic apparatus 100 may determine the current location of the electronic apparatus 100 without the location sensor. For example, the electronic apparatus 100 may determine the current location of the electronic apparatus 100 based on data obtained from at least one of the first distance sensor or the second distance sensor.

The tilt sensor may collect tilt data indicating the tilt of the electronic apparatus 100. The tilt data may be data indicating the degree by which the electronic apparatus 100 is tilted to a direction. The direction may indicate at least one of three-dimensional axes.

The electronic apparatus 100 may recognize the tilt of the electronic apparatus 100 based on the tilt data collected from the tilt sensor. The feature of recognizing the tilt may indicate recognizing in a tilt with respect to which axis the electronic apparatus 100 is rotated in a three-dimensional space. Explanation in this regard will be described in FIG. 13.

As an example, the tilt sensor may be implemented as a gyro sensor.

The vision sensor may collect data obtained from images. The electronic apparatus 100 may obtain image data through the vision sensor. The electronic apparatus 100 may detect an object based on the image data.

As an example, the vision sensor may be implemented as a camera.

The electronic apparatus 100 may obtain vertical surface data based on at least one of an edge, a direction, a location, a tilt, or an object. The vertical surface may indicate a plane that is perpendicular to the x axis direction (refer to FIG. 13) or a plane that is perpendicular to the y axis direction based on the driving direction of the electronic apparatus 100. The vertical surface may indicate a plane that is perpendicular to the horizontal surface.

The electronic apparatus 100 may obtain at least one of the distance between the electronic apparatus 100 and the edge, the location (direction) of the electronic apparatus 100 that recognized the edge, the tilt of the electronic apparatus 100, the distance between the electronic apparatus 100 and the object, or the location (direction) of the electronic apparatus 100 that recognized the object. The electronic apparatus 100 may obtain (or identify or generate) vertical surface data of a space based on the obtained information.

The vertical surface data may include the structure of a vertical surface of a space (or a target space). The structure of the vertical surface may include a spatial structure for at least one area.

According to various embodiments, the electronic apparatus 100 may perform a sensor operation used for obtaining the horizontal surface data of the embodiment 410 first, and then perform a sensor operation used for obtaining the vertical surface data of the embodiment 420.

FIG. 5 is a diagram for illustrating an operation of obtaining horizontal surface data and vertical surface data through the sensor part 121 according to an embodiment.

Referring to the embodiment 510 in FIG. 5, the sensor part 121 may include at least one of the first distance sensor, the second distance sensor, the acceleration sensor, the location sensor, the tilt sensor, or the vision sensor. Explanation in this regard was described in FIG. 4.

The electronic apparatus 100 may simultaneously perform sensor operations used in obtaining the horizontal surface data and the vertical surface data. The electronic apparatus 100 may receive data from at least one of the first distance sensor, the second distance sensor, the acceleration sensor, the location sensor, the tilt sensor, or the vision sensor. The electronic apparatus 100 may identify the horizontal surface data and the vertical surface data based on the received data.

As an example, the electronic apparatus 100 may detect an edge based on the distance data obtained through the first distance sensor. The electronic apparatus 100 may recognize the direction of the electronic apparatus 100 based on the acceleration data obtained through the acceleration sensor. The electronic apparatus 100 may obtain the horizontal surface data based on the detected edge and the recognized direction.

As an example, the electronic apparatus 100 may detect an edge based on the distance data obtained through the second distance sensor. The electronic apparatus 100 may recognize the direction of the electronic apparatus 100 based on the acceleration data obtained through the acceleration sensor. The electronic apparatus 100 may recognize the location of the electronic apparatus 100 based on the location data obtained through the location sensor. The electronic apparatus 100 may recognize the tilt of the electronic apparatus 100 based on the tilt data obtained through the tilt sensor. The electronic apparatus 100 may detect an object based on the image data obtained through the vision sensor.

The electronic apparatus 100 may obtain the vertical surface data based on at least one of the detected edge, the recognized direction, the recognized location, the recognized tilt, or the detected object.

If the location data is used, the electronic apparatus 100 may correctly identify the location of an object or the location of an edge, etc. According to various embodiments, the location data may not be used in obtaining the vertical surface data.

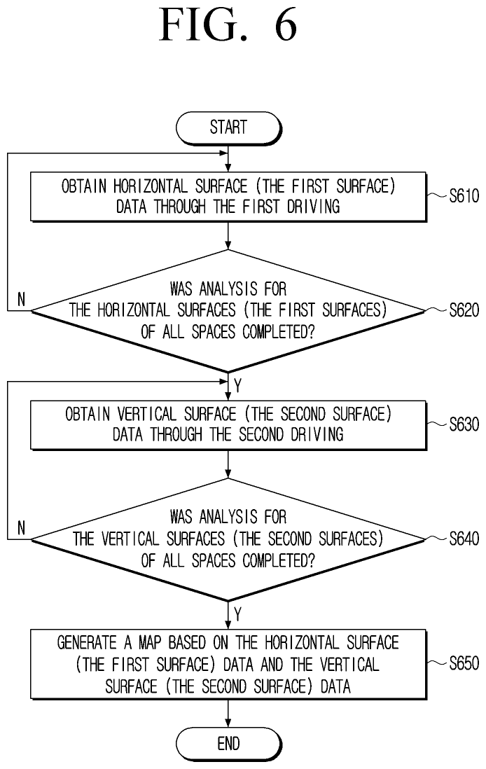

FIG. 6 is a diagram for illustrating an operation of generating a map according to an embodiment.

Referring to FIG. 6, the electronic apparatus 100 may obtain horizontal surface (the first surface) data through the first driving in the step S610. The electronic apparatus 100 may determine whether analysis for the horizontal surfaces (the first surfaces) of all spaces was completed in the step S620.

If the analysis was not completed in the step S620-N, the electronic apparatus 100 may repeatedly perform the step S610.

If the analysis was completed in the step S620-Y, the electronic apparatus 100 may obtain vertical surface (the second surface) data through the second driving in the step S630. The electronic apparatus 100 may determine whether analysis for the vertical surfaces (the second surfaces) of all spaces was completed in the step S640.

If the analysis was not completed in the step S640-N, the electronic apparatus 100 may repeatedly perform the step S630.

If the analysis was completed in the step S640-Y, the electronic apparatus 100 may generate a map based on the horizontal surface (the first surface) data and the vertical surface (the second surface) data in the step S650.

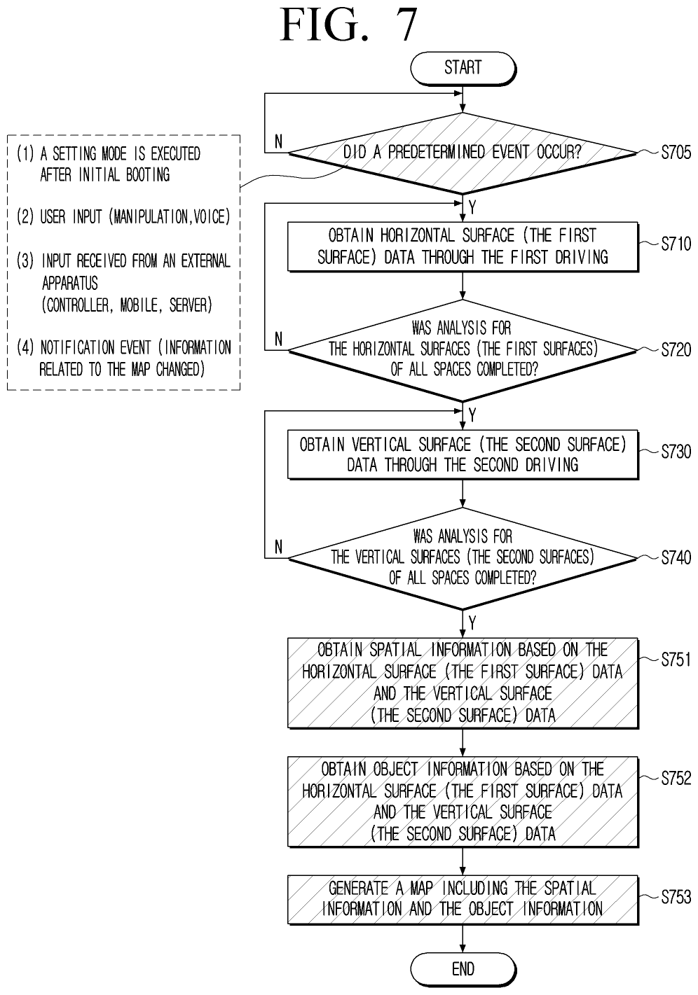

FIG. 7 is a diagram for illustrating an operation of generating a map based on a predetermined event according to an embodiment.

The steps S710, S720, S730, and S740 in FIG. 7 may correspond to the steps S610, S620, S630, and S640 in FIG. 6.

The electronic apparatus 100 may determine whether a predetermined event occurred in the step S705. The predetermined event may include at least one of an event wherein a setting mode is executed after initial booting, an event wherein a predetermined user input is received, an event wherein a predetermined input is received from an external apparatus, or a notification event.

An event wherein the setting mode is executed after initial booting may indicate an event wherein the setting mode is executed in case power is supplied in a factory initialization state or a setting initialization state.

An event where a predetermined user input is received may indicate an event wherein a user input requesting a map is received. The user input may be received through a voice or a manipulation.

An event wherein a predetermined input is received from an external apparatus may indicate an event wherein an input requesting a map is received from an external apparatus.

A notification event may indicate an event wherein a predetermined notification is generated. The predetermined notification may be a notification that information related to a map is changed. For example, a notification event may include a notification that the location of an object existing in a space is changed.

If the predetermined event occurred in the step S705-Y, the electronic apparatus 100 may perform the steps S710, S720, S730, and S740.

If analysis for the vertical surfaces (the second surfaces) of all spaces was completed in the step S740-Y, the electronic apparatus 100 may obtain spatial information based on the horizontal surface (the first surface) data and the vertical surface (the second surface) data in the step S751.

The electronic apparatus 100 may obtain object information based on the horizontal surface (the first surface) data and the vertical surface (the second surface) data in the step S752.

The electronic apparatus 100 may generate a map including the spatial information and the object information in the step S753.

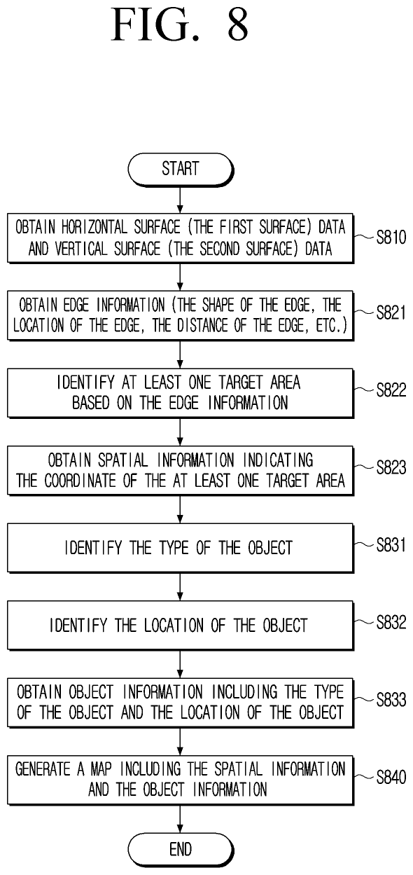

FIG. 8 is a diagram for illustrating an operation of generating a map based on spatial information and object information according to an embodiment.

Referring to FIG. 8, the electronic apparatus 100 may obtain horizontal surface (the first surface) data and vertical surface (the second surface) data in the step S810. The electronic apparatus 100 may obtain edge information based on the horizontal surface (the first surface) data and the vertical surface (the second surface) data in the step S821. The electronic apparatus 100 may identify data indicating an edge detected from the horizontal surface (the first surface) data and the vertical surface (the second surface) data. The electronic apparatus 100 may obtain edge information based on the identified data.

The edge information may include various information related to the detected edge. The edge information may include at least one of the shape of the edge, the location of the edge, or the distance of the edge.

The electronic apparatus 100 may identify at least one area based on the edge information in the step S822. The electronic apparatus 100 may identify at least one area in a space which is a subject for analysis. The electronic apparatus 100 may identify the structure of the edge by using the edge information. The electronic apparatus 100 may identify the structure of the edge through the location of the edge.

As an example, the electronic apparatus 100 may identify candidate areas wherein three edges are connected with one another within a threshold angle in the edge structure. The electronic apparatus 100 may identify an area having a structure which is opened in a direction wherein there is no edge among the candidate areas as the target area. The electronic apparatus 100 may identify an area wherein the length of the area having an opened structure is within a threshold distance as the target area.

The electronic apparatus 100 may identify at least one target area that satisfies a predetermined condition in a space. The electronic apparatus 100 may obtain spatial information indicating the coordinate of the at least one target area in the step S823.

The electronic apparatus 100 may detect an object based on the horizontal surface (the first surface) data and the vertical surface (the second surface) data. The electronic apparatus 100 may identify the type of the object in the step S831. The electronic apparatus 100 may identify the location of the object in the step S832. The electronic apparatus 100 may obtain object information including the type of the object and the location of the object in the step S833.

The electronic apparatus 100 may generate a map including the spatial information and the object information in the step S840.

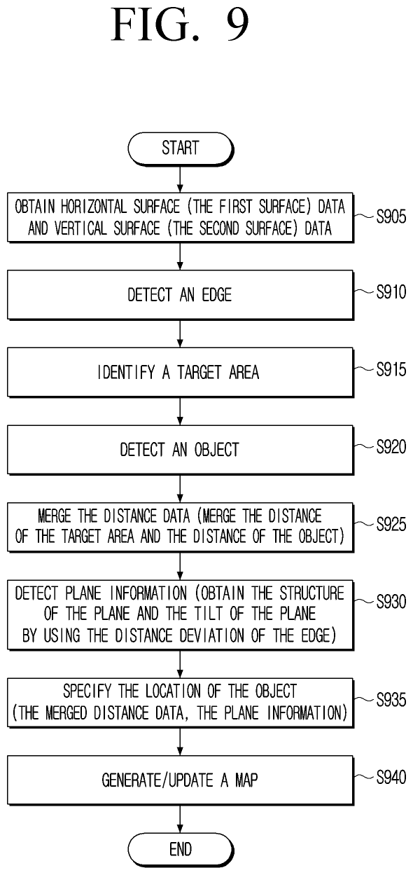

FIG. 9 is a diagram for illustrating an operation of generating a map by merging distance data according to an embodiment.

Referring to FIG. 9, the electronic apparatus 100 may obtain horizontal surface (the first surface) data and vertical surface (the second surface) data in the step S905.

The electronic apparatus 100 may detect an edge based on the horizontal surface (the first surface) data and the vertical surface (the second surface) data in the step S910. The electronic apparatus 100 may identify a target area based on the detected edge in the step S915. The target area may mean an area which is closed by a threshold ratio or more among the outer rim lines of the target area.

The electronic apparatus 100 may detect an object based on the horizontal surface (the first surface) data and the vertical surface (the second surface) data in the step S920.

After the target area and the object are identified, the electronic apparatus 100 may merge the distance data of the target area and the distance data of the object in the step S925. The electronic apparatus 100 may identify a relative location of the target area based on the electronic apparatus 100 by using the distance between the electronic apparatus 100 and the target area. The electronic apparatus 100 may identify a relative location of the object based on the electronic apparatus 100 by using the distance between the electronic apparatus 100 and the object.

The electronic apparatus 100 may merge the distance data of the target area and the distance data of the object. The distance data may be merged based on the direction in which the electronic apparatus 100 detected the distance data.

For example, the electronic apparatus 100 may obtain distance data of the target area detected in the first location and the first direction. The electronic apparatus 100 may obtain distance data of the object detected in the first location and the first direction. The electronic apparatus 100 may merge the distance data of the target area and the distance data of the object detected in the first location and the first direction. The first location may indicate a location (or a coordinate) in the space. The first direction may indicate the direction in which the electronic apparatus 100 detects data or the driving direction.

The electronic apparatus 100 may detect plane information based on the merged distance data in the step S930. The plane information may include at least one of the structure of the plane or the tilt of the plane.

The electronic apparatus 100 may obtain the structure of the plane by using the distance deviation of the edges. The electronic apparatus 100 may obtain the structure of the plane by using the distance deviation of the plurality of detected edges.

For example, the electronic apparatus 100 may obtain the first distance from the first location to the first edge and the second distance from the second location to the first edge. The electronic apparatus 100 may obtain the structure of the plane based on the deviation of the first distance and the second distance.

The electronic apparatus 100 may obtain the tilt of the plane by using the distance deviation of the edges. The electronic apparatus 100 may obtain the tilt of the plane by using the distance deviation of the plurality of detected edges.

For example, the electronic apparatus 100 may obtain the first distance from the first location to the first edge detected by the first tilt and the second distance from the second location to the first edge detected by the second tilt. The electronic apparatus 100 may obtain the tilt of the plane based on the deviation of the first tilt and the second tilt (the first deviation) and the deviation of the first distance and the second distance (the second deviation).

The electronic apparatus 100 may identify (or specify) the location of the object based on the merged distance data and the plane information in the step S935.

The electronic apparatus 100 may generate (or update) a map based on the plane information and the location of the object in the step S940.

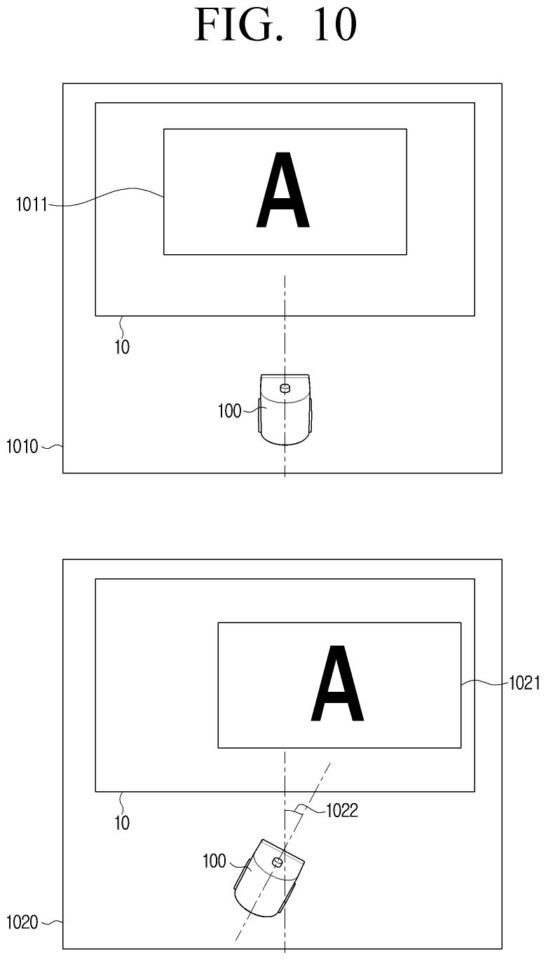

FIG. 10 is a diagram for illustrating a horizontal tilt (a tilt in a yaw direction) according to an embodiment.

Referring to FIG. 10, according to the embodiment 1010, the electronic apparatus 100 may output a projection image 1011 on a projection surface 10 in a horizontal projection direction. It is assumed that the horizontal tilt is 0. The horizontal tilt may mean the degree by which the electronic apparatus 100 is tilted to the left side or the right side toward the front side.

According to the embodiment 1020, the electronic apparatus 100 may output a projection image 1021 on the projection surface 10 in a horizontal projection direction. It is assumed that the horizontal tilt 1022 is 30 degrees. In case the horizontal tilt is 30 degrees to the right side, the electronic apparatus 100 may output the projection image 1021 on the right side by 30 degrees to the right side on the projection surface 10.

The electronic apparatus 100 may obtain horizontal surface data and vertical surface data based on the horizontal tilt. The electronic apparatus 100 may obtain sensor data based on the horizontal tilt. The electronic apparatus 100 may obtain at least one of the horizontal surface data or the vertical surface data based on the horizontal tilt and the sensor data.

The horizontal tilt may indicate a rotation angle (yaw) based on the z axis in FIG. 13. The horizontal tilt may be described as a yaw angle.

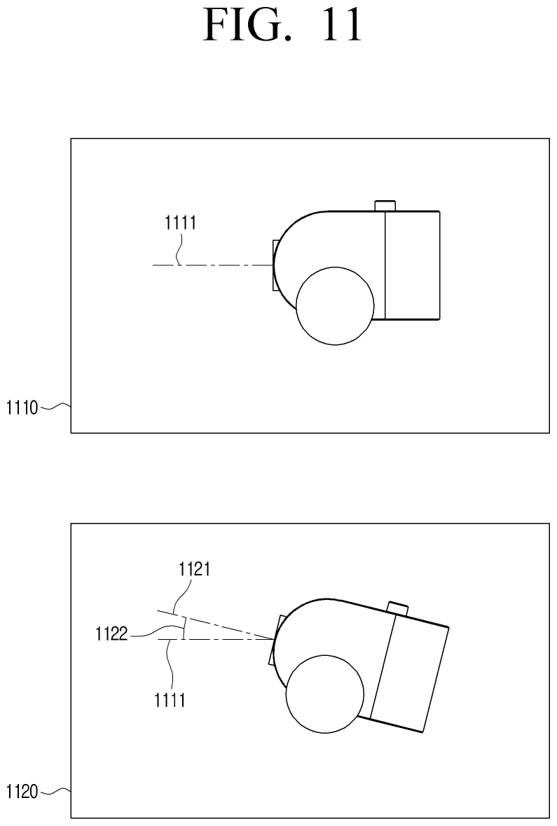

FIG. 11 is a diagram for illustrating a vertical tilt (a tilt in a pitch direction) according to an embodiment.

Referring to FIG. 11, according to the embodiment 1110, the electronic apparatus 100 may output a projection image on a projection surface in a horizontal projection direction. It is assumed that the vertical tilt is 0. The vertical tilt may mean the degree by which the electronic apparatus 100 is tilted to the upper side or the lower side toward the front side.

If the vertical tilt is 0, it may be a situation wherein the projection image is output horizontally. The virtual line 1111 indicating the bottom surface and the virtual line 1111 in which the electronic apparatus 100 is toward the front side may be identical (or parallel).

According to the embodiment 1120, the electronic apparatus 100 may output a projection image on the projection surface in a horizontal projection direction. It is assumed that the vertical tilt 1122 is 30 degrees. In case the vertical tilt is 30 degrees to the upper side, the electronic apparatus 100 may output the projection image on the upper side by 30 degrees to the upper side on the projection surface. The virtual line 1111 indicating the bottom surface and the virtual line 1121 in which the electronic apparatus 100 is toward the front side may not be parallel. The vertical tilt 1122 may indicate an angle between the virtual line 1111 indicating the bottom surface and the virtual line 1121 in which the electronic apparatus 100 is toward the front side.

The electronic apparatus 100 may obtain horizontal surface data and vertical surface data based on the vertical tilt. The electronic apparatus 100 may obtain sensor data based on the vertical tilt. The electronic apparatus 100 may obtain at least one of the horizontal surface data or the vertical surface data based on the vertical tilt and the sensor data.

The vertical tilt may indicate a rotation angle (pitch) based on the y axis in FIG. 13. The vertical tilt may be described as a pitch angle.

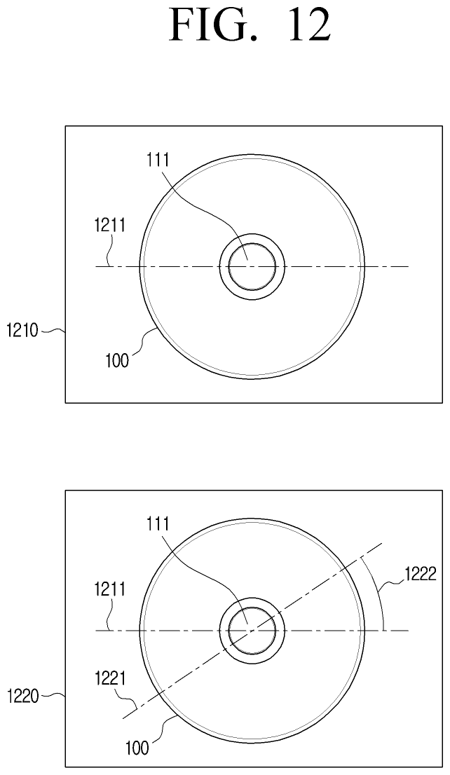

FIG. 12 is a diagram for illustrating horizontal warping (a tilt in a roll direction) according to an embodiment.

Referring to FIG. 12, according to the embodiment 1210, the electronic apparatus 100 may output a projection image without horizontal warping. The reference line wherein there is no horizontal warping is indicated as the horizontal line 1211. According to the embodiment 1210, the reference horizontal line and the horizontal line of the electronic apparatus 100 may coincide.

According to the embodiment 1220, the electronic apparatus 100 may have horizontal warping 1222 by 30 degrees to the right side. The reference line 1211 and the horizontal line 1221 of the electronic apparatus 100 may be different as much as the horizontal warping 1222.

The electronic apparatus 100 may obtain horizontal surface data and vertical surface data based on the horizontal warping. The electronic apparatus 100 may obtain sensor data based on the horizontal warping. The electronic apparatus 100 may obtain at least one of the horizontal surface data or the vertical surface data based on the horizontal warping and the sensor data.

The horizontal warping may indicate a rotation angle (roll) based on the x axis in FIG. 13. The horizontal warping may be described as a roll angle.

FIG. 13 is a diagram for illustrating rotation information of the electronic apparatus 100 according to an embodiment.

FIG. 13 is a diagram for illustrating horizontal warping, a horizontal tilt, and a vertical tilt of the electronic apparatus 100.

The embodiment 1310 in FIG. 13 is a graph that defined rotation directions according to the x, y, and z axes. Rotating based on the x axis may be defined as a roll, rotating based on the y axis may be defined as a pitch, and rotating based on the z axis may be defined as a yaw.

In the embodiment 1320 in FIG. 13, the rotation direction of the projection surface 10 may be explained as the rotation direction defined in the embodiment 1310. The x axis rotation information of the projection surface 10 may correspond to a roll of rotating based on the x axis of the projection surface 10. The y axis rotation information of the projection surface 10 may correspond to a pitch of rotating based on the y axis of the projection surface 10. The z axis rotation information of the projection surface 10 may correspond to a yaw of rotating based on the z axis of the projection surface 10.

The x axis rotation information may be described as the first axis rotation information, the first axis tilt information, or the horizontal warping information.

The y axis rotation information may be described as the second axis rotation information, the second axis tilt information, or the vertical warping information.

The z axis rotation information may be described as the third axis rotation information, the third axis tilt information, or the horizontal warping information.

The sensor part 121 may obtain state information of the electronic apparatus 100. The state information of the electronic apparatus 100 may mean the rotation state of the electronic apparatus 100. The sensor part 121 may include at least one of a gravity sensor, an acceleration sensor, or a gyro sensor. The x axis rotation information of the electronic apparatus 100 and the y axis rotation information of the electronic apparatus 100 may be determined based on the sensor data obtained through the sensor part 121. However, it may be difficult to set a standard for the z axis rotation information of the electronic apparatus 100 unless north, south, east, and west directions, etc. are set as the standard. Accordingly, the electronic apparatus 100 may consider the state information of the projection surface 10 without separately considering the z axis rotation information of the electronic apparatus 100. The electronic apparatus 100 may perform an image correcting operation in consideration of the z axis rotation information of the projection surface 10.

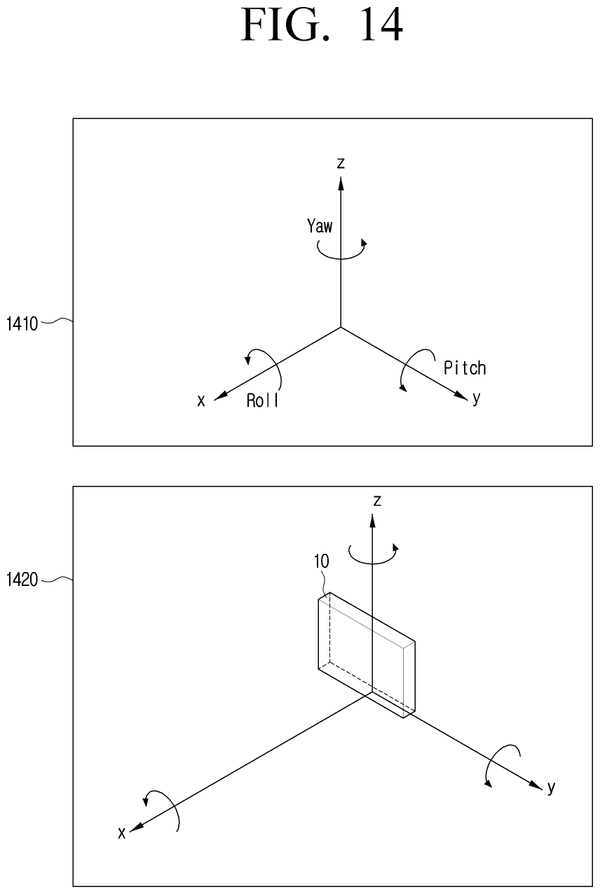

FIG. 14 is a diagram for illustrating rotation information of a projection surface according to an embodiment.

The embodiment 1410 in FIG. 14 is a graph that defined rotation directions according to x, y, and z axes. Rotating based on the x axis may be defined as a roll, rotating based on the y axis may be defined as a pitch, and rotating based on the z axis may be defined as a yaw.

In the embodiment 1420 in FIG. 14, the rotation direction of the projection surface 10 may be explained as the rotation direction defined in the embodiment 1410. The x axis rotation information of the projection surface 10 may correspond to a roll of rotating based on the x axis of the projection surface 10. The y axis rotation information of the projection surface 10 may correspond to a pitch of rotating based on the y axis of the projection surface 10. The z axis rotation information of the projection surface 10 may correspond to a yaw of rotating based on the z axis of the projection surface 10.

The x axis rotation information may be described as the first axis rotation information. The y axis rotation information may be described as the second axis rotation information. The z axis rotation information may be described as the third axis rotation information.

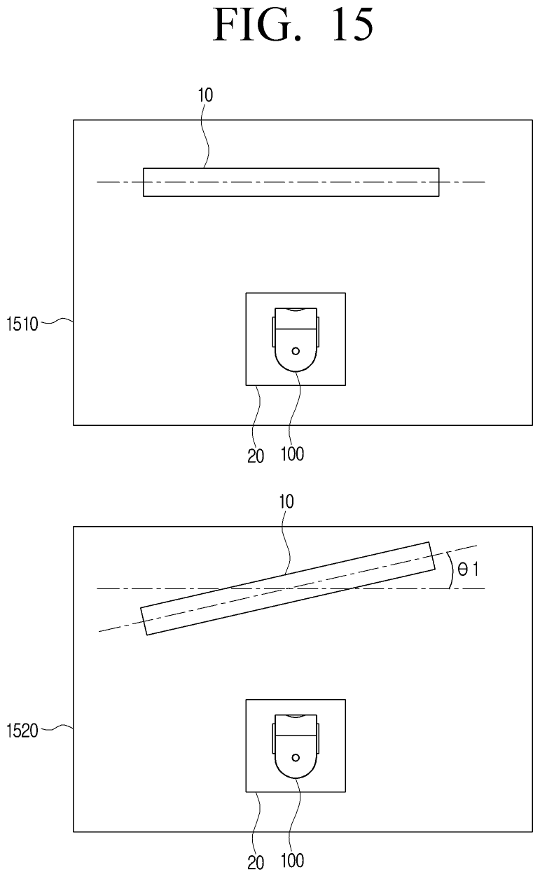

FIG. 15 is a diagram for illustrating rotation information of a z axis of a projection surface according to an embodiment.

The embodiment 1510 in FIG. 15 is a graph that views a situation wherein the electronic apparatus 100 outputs a projection image while the projection surface 10 did not rotate to the z axis from the upper side of the electronic apparatus 100. It is assumed that the electronic apparatus 100 is placed on the table 20.

The embodiment 1520 in FIG. 15 is a diagram that views a situation wherein the electronic apparatus 100 outputs a projection image while the projection surface 10 rotated by an angle θ1 in a counter-clockwise direction based on the z axis from the upper side of the electronic apparatus 100. It is assumed that the electronic apparatus 100 is placed on the table 20.

The electronic apparatus 100 may identify that the projection surface 10 is tilted by the angle θ1. The electronic apparatus 100 may also identify that the projection surface 10 is tilted by the angle θ1 in the yaw direction.

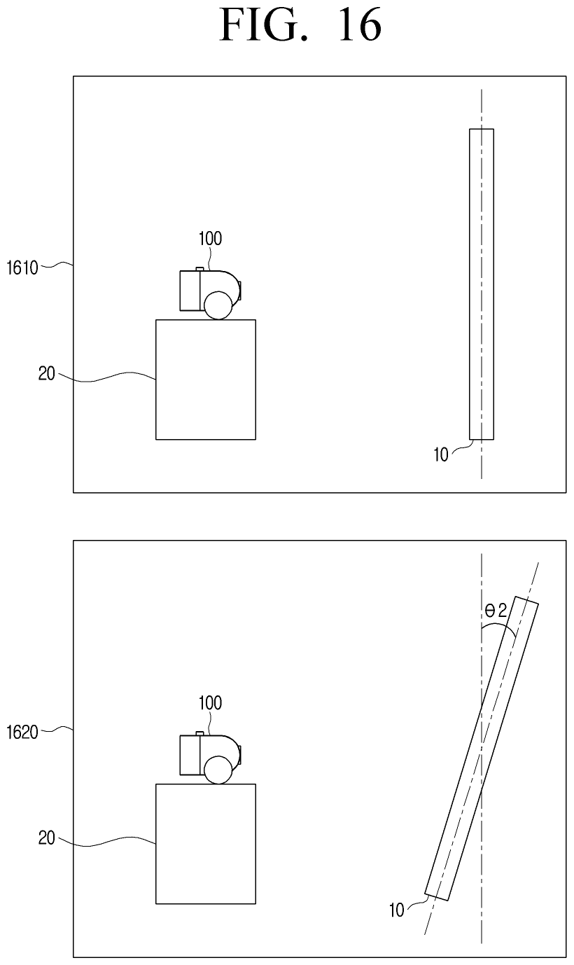

FIG. 16 is a diagram for illustrating rotation information of a y axis of a projection surface according to an embodiment.

Referring to the embodiment 1610 in FIG. 16, it indicates a state wherein the projection surface 10 did not rotate based on the y axis.

Referring to the embodiment 1620 in FIG. 16, it indicates a state wherein the projection surface 10 rotated based on the y axis. The projection surface 10 may be rotated by an angle θ2 based on the y axis.

The electronic apparatus 100 may identify that the projection surface 10 is tilted by the angle θ2. The electronic apparatus 100 may also identify that the projection surface 10 is tilted by the angle θ2 in the pitch direction.

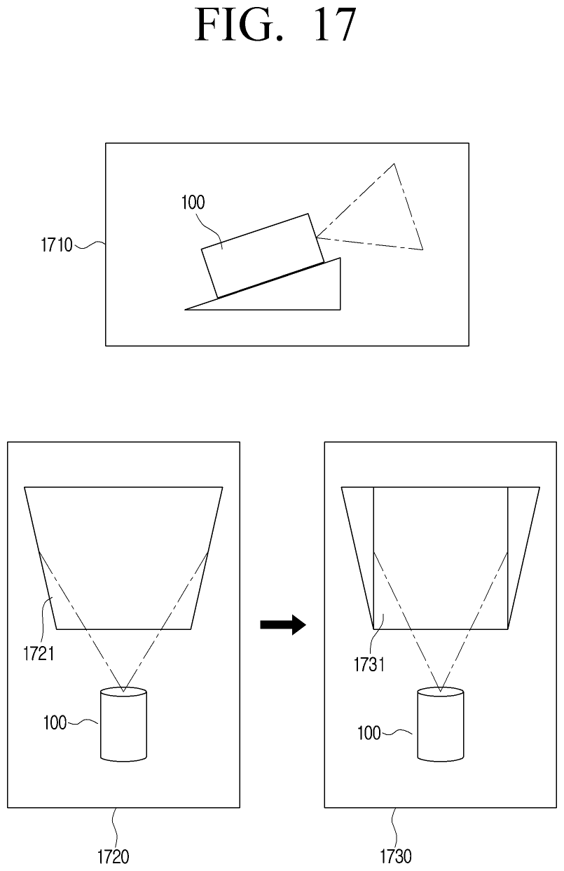

FIG. 17 is a diagram for illustrating an operation of performing a keystone function in consideration of a vertical tilt according to an embodiment.

Referring to the embodiment 1710 in FIG. 17, the electronic apparatus 100 may output a projection image while a vertical tilt exists.

Referring to the embodiment 1720, the electronic apparatus 100 may output a projection image 1721 while a vertical tilt exists, and due to the vertical tilt, the projection image 1721 may be output in a trapezoid form but not a rectangle which is the form of the original image. For resolving the problem that is generated due to the presence of a vertical tilt, the electronic apparatus 100 may perform a keystone function.

Referring to the embodiment 1730, the electronic apparatus 100 may perform the keystone function such that the projection image 1731 that is finally output by modifying the original image becomes a rectangle form.

The electronic apparatus 100 may obtain sensor data while being tilted in the pitch direction. The electronic apparatus 100 may obtain horizontal surface data and vertical surface data based on the sensor data obtained while being tilted in the pitch direction.

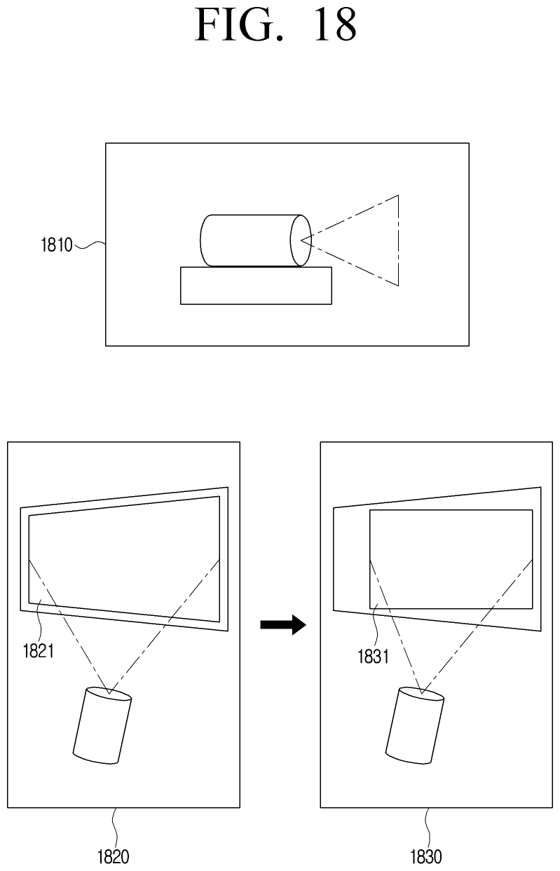

FIG. 18 is a diagram for illustrating an operation of performing a keystone function in consideration of a horizontal tilt according to an embodiment.

Referring to the embodiment 1810 in FIG. 18, the electronic apparatus 100 may output a projection image while a horizontal tilt exists.

Referring to the embodiment 1820, the electronic apparatus 100 may output a projection image 1821 while a horizontal tilt exists, and due to the horizontal tilt, the projection image 1821 may be output in a trapezoid form but not a rectangle which is the form of the original image. For resolving the problem that is generated due to the presence of a horizontal tilt, the electronic apparatus 100 may perform the keystone function.

Referring to the embodiment 1830, the electronic apparatus 100 may perform the keystone function such that the projection image 1831 that is finally output by modifying the original image becomes a rectangle form.

The electronic apparatus 100 may obtain sensor data while being tilted in the yaw direction. The electronic apparatus 100 may obtain horizontal surface data and vertical surface data based on the sensor data obtained while being tilted in the yaw direction.

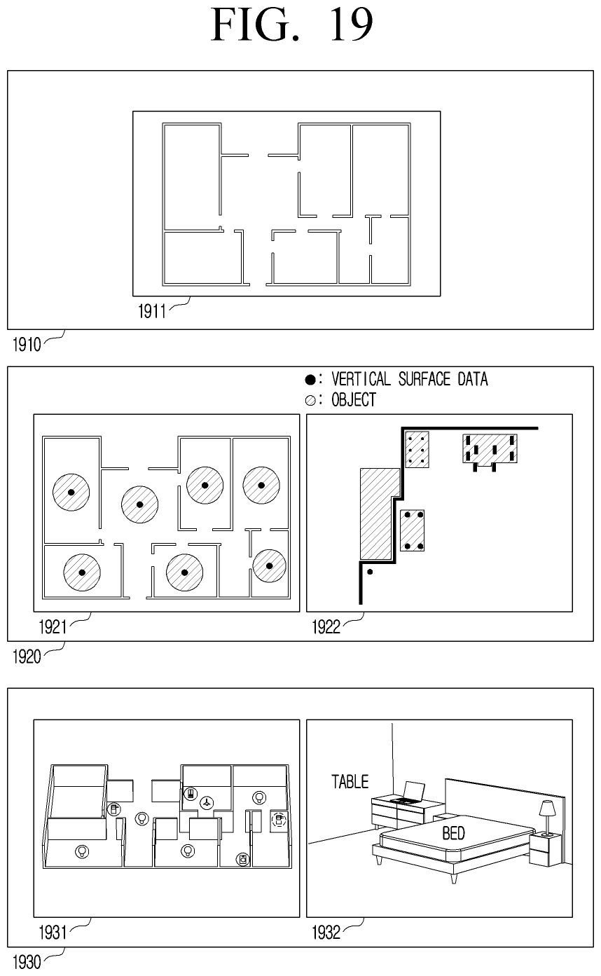

FIG. 19 is a diagram for illustrating a map of a horizontal surface, a map of a vertical surface, and a three-dimensional map according to an embodiment.

Referring to the embodiment 1910 in FIG. 19, the electronic apparatus 100 may obtain a map of a horizontal surface 1911 based on horizontal surface data. The map of the horizontal surface 1911 may include information on a two-dimensional horizontal surface for a target space analyzed by the electronic apparatus 100. The map of the horizontal surface 1911 may mean a map of a plane viewed from the z axis direction in the space wherein the electronic apparatus 100 is arranged (refer to FIG. 13). Also, the map of the horizontal surface 1911 may mean a map of an x-y plane in the space wherein the electronic apparatus 100 is arranged (refer to FIG. 13).

Referring to the embodiment 1920 in FIG. 19, the electronic apparatus 100 may obtain maps of vertical surfaces 1921, 1922 based on vertical surface data. The maps of the vertical surfaces 1921, 1922 may include information on vertical surfaces for a target space analyzed by the electronic apparatus 100. The maps of the vertical surfaces 1921, 1922 may mean maps including information on the z axis in the space wherein the electronic apparatus 100 is arranged (refer to FIG. 13). The maps of the vertical surfaces 1921, 1922 may mean maps of surfaces perpendicular to the x-y plane in the space wherein the electronic apparatus 100 is arranged (refer to FIG. 13).

According to various embodiments, the electronic apparatus 100 may obtain the map of the horizontal surface 1911, and then obtain vertical surface data. The electronic apparatus 100 may obtain the maps of the vertical surfaces 1921, 1922 by reflecting the vertical surface data to the map of the horizontal surface 1911. The electronic apparatus 100 may identify an edge included in the map of the horizontal surface 1911, and identify z axis information of the identified edge. The electronic apparatus 100 may identify the maps of the vertical surfaces 1921, 1922 by using the identified z axis information of the edge.

Referring to the embodiment 1930 in FIG. 19, the electronic apparatus 100 may obtain three-dimensional maps 1931, 1932 based on the map of the horizontal surface 1911 and the maps of the vertical surfaces 1921, 1922. The three-dimensional maps 1931, 1932 may be maps that implemented a target space which is a subject of analysis in a three-dimensional form.

According to various embodiments, the three-dimensional map 1932 may include information related to an object. The information related to an object may include at least one of the type of the object (e.g., a stand lighting, a couch, a table, a chair, etc.) or the location of the object. The three-dimensional map 1932 may include a spatial structure and an object arranged in a location. The user may recognize in which location the object is located in a three-dimensional form through the three-dimensional map 1932.

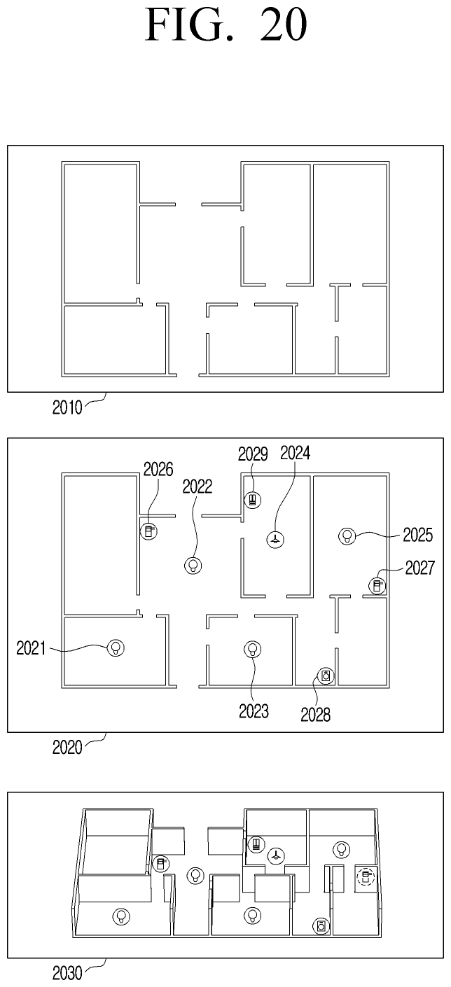

FIG. 20 is a diagram for illustrating a three-dimensional map according to an embodiment.

Referring to FIG. 20, the electronic apparatus 100 may obtain a three-dimensional map 2010 of a first type. The three-dimensional map 2010 of the first type may be a three-dimensional map not including object information. The three-dimensional map 2010 of the first type may be a map that is obtained by combining a map of a horizontal surface and a map of a vertical surface.

The electronic apparatus 100 may obtain a three-dimensional map 2020 of a second type by considering the object information in the three-dimensional map 2010 of the first type. The electronic apparatus 100 may reflect the information indicating the type of the object and the location information of the object to the three-dimensional map 2010 of the first type. The electronic apparatus 100 may generate the three-dimensional map 2020 of the second type wherein UIs 2021, 2022, 2023, 2024, 2025, 2026, 2027, 2028, 2029 indicating objects in locations in the three-dimensional map 2010 of the first type are displayed.

The information indicating the type of the object may include at least one of a text indicating the type of the object or an image (e.g., an icon) indicating the type of the object.

The electronic apparatus 100 may provide the three-dimensional map 2020 of the second type to the user.

As an example, the electronic apparatus 100 may display the three-dimensional map 2020 of the second type through the display included in the electronic apparatus 100.

As an example, the electronic apparatus 100 may output the three-dimensional map 2020 of the second type through the projection part 112 included in the electronic apparatus 100.

The electronic apparatus 100 may obtain a three-dimensional map 2030 of a third type that is expressed in a different perspective from the three-dimensional map 2020 of the second type. The electronic apparatus 100 may provide the three-dimensional map 2030 of the third type.

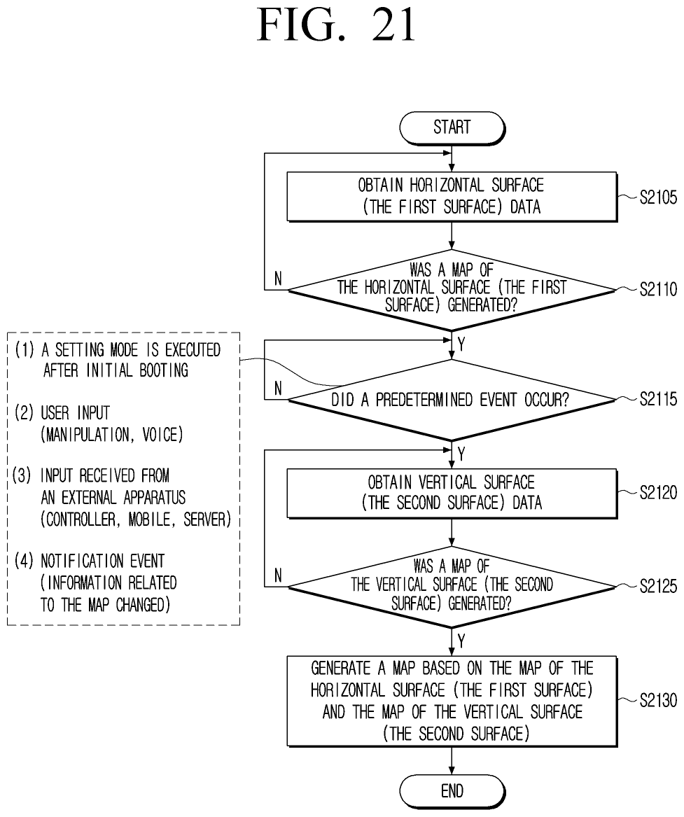

FIG. 21 is a diagram for illustrating an operation of generating a map (a three-dimensional map or a combined map) by using a map of a horizontal surface and a map of a vertical surface according to an embodiment.

Referring to FIG. 21, the electronic apparatus 100 may obtain horizontal surface (the first surface) data in the step S2105. The electronic apparatus 100 may determine whether a map of the horizonal surface (the first surface) was generated in the step S2110.

If a map of the horizonal surface (the first surface) was not generated in the step S2110-N, the electronic apparatus 100 may repeatedly perform the step S2105.

If a map of the horizonal surface (the first surface) was generated in the step S2110-Y, the electronic apparatus 100 may identify whether a predetermined event occurred in the step S2115.

The predetermined event may include at least one of an event wherein a closed space of which three surfaces are blocked is identified based on the horizonal surface (the first surface) data, an event wherein a predetermined space (e.g., a room, a living room, etc.) is recognized based on the image data, or an event wherein a predetermined user input is received (e.g., a manipulation input for a button, a voice input including a word).

An event wherein a closed space of which three surfaces are blocked is identified may include an event in which a space wherein three edges constituted within a threshold angle form an area of which surfaces are closed excluding one surface among four surfaces is identified.

If the predetermined event is identified in the step S2155-Y, the electronic apparatus 100 may obtain vertical surface (the second surface) data in the step S2120. The electronic apparatus 100 may determine whether a map of the vertical surface (the second surface) was generated in the step S2125.

If a map of the vertical surface (the second surface) was not generated in the step S2125-N, the electronic apparatus 100 may repeatedly perform the step S2120.

If a map of the vertical surface (the second surface) was generated in the step S2125-Y, the electronic apparatus 100 may generate a map (a three-dimensional map or a combined map) based on the map of the horizonal surface (the first surface) and the map of the vertical surface (the second surface) in the step S2130.

FIG. 22 is a diagram for illustrating an operation of obtaining a map through the server 200 according to an embodiment.

The steps S2205, S2210, S2230, S2251, S2252, and S2253 in FIG. 22 may correspond to the steps S705, S710, S730, S751, S752, and S753 in FIG. 7.

However, the subject of some operations may be the server 200 unlike in FIG. 7.

The electronic apparatus 100 may be communicatively connected with the server 200. The server 200 may be a server that is connected with the electronic apparatus 100 and provides a map to the electronic apparatus 100. As an example, the server 200 may be a server that manages the electronic apparatus 100. Also, as an example, the server 200 may be an Internet of Things (IoT) server.

According to a predetermined event, the electronic apparatus 100 may obtain horizonal surface (the first surface) data through the first driving in the step S2210. The electronic apparatus 100 may obtain vertical surface (the second surface) data through the second driving in the step S2230. The electronic apparatus 100 may transmit the horizonal surface (the first surface) data and the vertical surface (the second surface) data to the server 200 in the step S2235.

According to various embodiments, the electronic apparatus 100 may transmit the horizonal surface (the first surface) data first, and after transmitting the horizonal surface (the first surface) data, transmit the vertical surface (the second surface) data.

The server 200 may receive the horizonal surface (the first surface) data and the vertical surface (the second surface) data from the electronic apparatus 100. The server 200 may obtain spatial information based on the horizonal surface (the first surface) data and the vertical surface (the second surface) data in the step S2251. The server 200 may obtain object information based on the horizonal surface (the first surface) data and the vertical surface (the second surface) data in the step S2252.

The server 200 may generate a map including the spatial information and the object information in the step S2253. The server 200 may transmit the map to the electronic apparatus 100 in the step S2260.

The electronic apparatus 100 may receive the map from the server 200 in the step S2260. The electronic apparatus 100 may display the map in the step S2265.

According to various embodiments, the operations described in FIG. 6 to FIG. 9 other than the operations described in FIG. 22 may selectively be performed in the server 200.

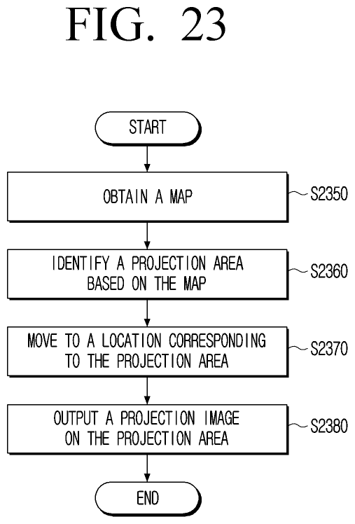

FIG. 23 is a diagram for illustrating an operation of outputting a projection image according to an embodiment.

Referring to FIG. 23, the electronic apparatus 100 may obtain a map in the step S2350. After obtaining the map, the electronic apparatus 100 may identify a projection area based on the map in the step S2360. The electronic apparatus 100 may identify a plane of a threshold size or bigger in the map. The electronic apparatus 100 may identify the plane of the threshold size or bigger identified in the map as the projection area.

According to various embodiments, the electronic apparatus 100 may provide a map to the user, and receive a user input selecting a projection area through the provided map. The electronic apparatus 100 may determine the projection area based on the received user input.

The electronic apparatus 100 may move to a location corresponding to the projection area in the step S2370. The location corresponding to the projection area may indicate a location to which the electronic apparatus 100 should move for outputting a projection image in the projection area.

After the electronic apparatus 100 moves to the location corresponding to the projection area, the electronic apparatus 100 may output a projection image in the projection area in the step S2380.

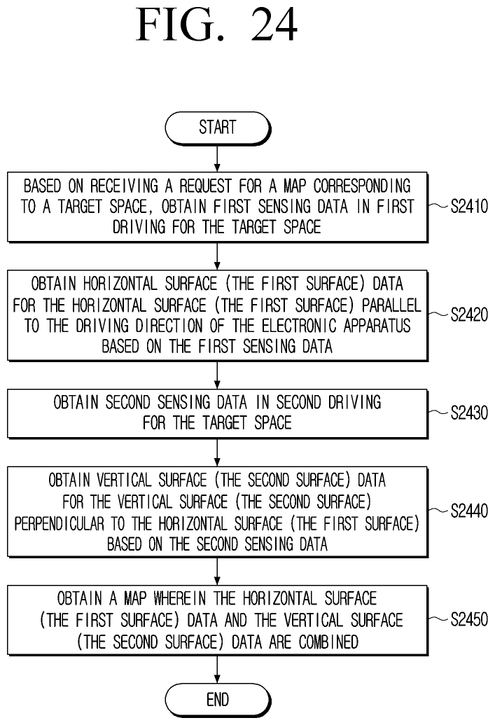

FIG. 24 is a diagram for illustrating a controlling method of the electronic apparatus 100 according to an embodiment.

Referring to FIG. 24, a controlling method of an electronic apparatus includes the steps of, based on receiving a request for a map corresponding to a target space, obtaining first sensor data in first driving for the target space (S2410), obtaining horizontal surface (the first surface) data for the horizontal surface (the first surface) parallel to the driving direction of the electronic apparatus based on the first sensor data (S2420), obtaining second sensor data in second driving for the target space (S2430), obtaining vertical surface (the second surface) data for the vertical surface (the second surface) perpendicular to the horizontal surface (the first surface) based on the second sensor data (S2440), and obtaining a map wherein the horizontal surface (the first surface) data and the vertical surface (the second surface) data are combined (S2450).

The horizontal surface (the first surface) data may include information on the horizontal surface (the first surface) including an x axis and a y axis based on the driving direction of the electronic apparatus, and the vertical surface (the second surface) data may include information on the vertical surface (the second surface) including a z axis based on the driving direction of the electronic apparatus.

In the step S2320 of obtaining the horizontal surface (the first surface) data, the horizontal surface (the first surface) data including first spatial information of the horizontal surface (the first surface) and first object information of the horizontal surface (the first surface) may be obtained based on the first sensor data.

The electronic apparatus may include a first distance sensor and an acceleration sensor, and the first sensor data may include first distance data obtained through the first distance sensor and first acceleration data obtained through the acceleration sensor, and in the step S2320 of obtaining the horizontal surface (the first surface) data, first edge information may be detected based on the first distance data, first direction information of the electronic apparatus may be obtained based on the first acceleration data, and the horizontal surface (the first surface) data including the first spatial information and the first object information may be obtained based on the first edge information and the first direction information.

In the step S2340 of obtaining the vertical surface (the second surface) data, the vertical surface (the second surface) data including the second spatial information of the vertical surface (the second surface) and the second object information of the vertical surface (the second surface) may be obtained based on the second sensor data.

The electronic apparatus may include a second distance sensor and an acceleration sensor, and the second sensor data may include second distance data obtained through the second distance sensor and second acceleration data obtained through the acceleration sensor, and in the step S2340 of obtaining the vertical surface (the second surface) data, second edge information may be detected based on the second distance data, second direction information of the electronic apparatus may be obtained based on the second acceleration data, and the vertical surface (the second surface) data including the second spatial information and the second object information may be obtained based on the second edge information and the second direction information.

The electronic apparatus may include a vision sensor, and the second sensor data may include the second distance data, the second acceleration data, and image data obtained through the vision sensor, and the controlling method may include the step of updating the second object information based on the image data.

The electronic apparatus may include a tilt sensor, and the second sensor data may include the second distance data, the second acceleration data, and tilt data obtained through the tilt sensor, and the controlling method may include the steps of obtaining a first tilt angle in a roll direction, a second tilt angle in a pitch direction, and a third tilt angle in a yaw direction of the electronic apparatus based on the tilt data, and updating the second spatial information based on the first tilt angle, the second tilt angle, and the third tilt angle.

The first distance sensor may be a LiDAR sensor, the second distance sensor may be a Time of Flight (ToF) sensor, and the tilt sensor may be a gyro sensor.

In the step S2350 of obtaining the map, third spatial information may be obtained by combining the first spatial information and the second spatial information based on the same location, third object information may be obtained by combining the first object information and the second object information based on the same location, and the map including the third spatial information and the third object information may be obtained.

The methods according to the aforementioned various embodiments of the disclosure may be implemented in forms of applications that can be installed on conventional electronic apparatuses.

Also, the methods according to the aforementioned various embodiments of the disclosure may be implemented just with software upgrade, or hardware upgrade for a conventional electronic apparatus.

In addition, the aforementioned various embodiments of the disclosure may also be performed through an embedded server provided on an electronic apparatus, or an external server of at least one of an electronic apparatus or a display apparatus.

According to an embodiment of the disclosure, the aforementioned various embodiments may be implemented as software including instructions stored in machine-readable storage media, which can be read by machines (e.g.: computers). Here, the machines refer to apparatuses that call instructions stored in a storage medium, and can operate according to the called instructions, and the apparatuses may include the electronic apparatus according to the aforementioned embodiments. In case an instruction is executed by a processor, the processor may perform a function corresponding to the instruction by itself, or by using other components under its control. An instruction may include a code that is generated or executed by a compiler or an interpreter. A storage medium that is readable by machines may be provided in the form of a non-transitory storage medium. Here, the term ‘non-transitory’ only means that a storage medium does not include signals, and is tangible, but does not indicate whether data is stored in the storage medium semi-permanently or temporarily.

Also, according to an embodiment of the disclosure, the methods according to the aforementioned various embodiments may be provided while being included in a computer program product. A computer program product refers to a product, and it can be traded between a seller and a buyer. A computer program product can be distributed in the form of a storage medium that is readable by machines (e.g.: compact disc read only memory (CD-ROM)), or may be distributed on-line through an application store. In the case of on-line distribution, at least a portion of a computer program product may be stored in a storage medium such as the server of the manufacturer, the server of the application store, and the memory of the relay server at least temporarily, or may be generated temporarily.

Also, each of the components (e.g.: a module or a program) according to the aforementioned various embodiments may consist of a singular object or a plurality of objects. In addition, among the aforementioned corresponding sub components, other sub components may be further included in the various embodiments. Some components (e.g.: a module or a program) may be integrated as an object, and perform functions that were performed by each of the components before integration identically or in a similar manner. Also, operations performed by a module, a program, or other components according to the various embodiments may be executed sequentially, in parallel, repetitively, or heuristically. Or, at least some of the operations may be executed in a different order, or other operations may be added.

In addition, while example embodiments of the disclosure have been shown and described, the disclosure is not limited to the aforementioned embodiments, and it is apparent that various modifications may be made by those having ordinary skill in the technical field to which the disclosure belongs, without departing from the gist of the disclosure as claimed by the appended claims. Further, it is intended that such modifications are not to be interpreted independently from the technical idea of the disclosure.

What is claimed is:

1. An electronic apparatus comprising:
memory;
at least one sensor;
at least one processor operatively connected with the memory and the at least one sensor, and configured to execute instructions,
wherein the instructions, when executed by the at least one processor, cause the electronic apparatus to:
based on receiving a request for a map corresponding to a target space, obtain first surface data for a first surface corresponding to a driving direction of the electronic apparatus based on first sensor data obtained through the at least one sensor in first driving for the target space,
obtain second surface data for a second surface different from the first surface based on second sensor data obtained through the at least one sensor in second driving for the target space, and
obtain the map based on the first surface data and the second surface data.

2. The electronic apparatus of claim 1, wherein the first surface data comprises first information corresponding to a horizontal surface including an x axis and a y axis based on the driving direction of the electronic apparatus, and
wherein the second surface data comprises second information corresponding to a vertical surface including a z axis based on the driving direction of the electronic apparatus.

3. The electronic apparatus of claim 1, wherein the first surface data comprises first spatial information of the first surface and first object information of the first surface.

4. The electronic apparatus of claim 3, wherein the at least one sensor comprises:
a first distance sensor, and an acceleration sensor,
wherein the first sensor data comprises first distance data obtained through the first distance sensor and first acceleration data obtained through the acceleration sensor, and
wherein the instructions, when executed by the at least one processor, cause the electronic apparatus to:
detect first edge information based on the first distance data,
obtain first direction information of the electronic apparatus based on the first acceleration data, and
obtain the first surface data based on the first edge information and the first direction information.

5. The electronic apparatus of claim 4, wherein the second surface data comprises second spatial information of the second surface and second object information of the second surface.

6. The electronic apparatus of claim 5, wherein the at least one sensor further comprises:
a second distance sensor, and
wherein the second sensor data comprises second distance data obtained through the second distance sensor and second acceleration data obtained through the acceleration sensor, and
wherein the instructions, when executed by the at least one processor, cause the electronic apparatus to:
detect second edge information based on the second distance data,
obtain second direction information of the electronic apparatus based on the second acceleration data, and
obtain the second surface data based on the second edge information and the second direction information.

7. The electronic apparatus of claim 6, wherein the at least one sensor further comprises a vision sensor,
wherein the second sensor data further comprises image data obtained through the vision sensor, and
wherein the instructions, when executed by the at least one processor, cause the electronic apparatus to update the second object information based on the image data.

8. The electronic apparatus of claim 6, wherein the at least one sensor further comprises a tilt sensor,
wherein the second sensor data further comprises tilt data obtained through the tilt sensor, and
wherein the instructions, when executed by the at least one processor, cause the electronic apparatus to:
obtain, based on the tilt data, a first tilt angle in a roll direction, a second tilt angle in a pitch direction, and a third tilt angle in a yaw direction, of the electronic apparatus, and
update the second spatial information based on the first tilt angle, the second tilt angle, and the third tilt angle.

9. The electronic apparatus of claim 8, wherein the first distance sensor is a Light Detection and Ranging (LiDAR) sensor, the second distance sensor is a Time of Flight (ToF) sensor, and the tilt sensor is a gyro sensor.

10. The electronic apparatus of claim 6, wherein the instructions, when executed by the at least one processor, cause the electronic apparatus to:
obtain, based on the first spatial information and the second spatial information corresponding to a same location, third spatial information by combining the first spatial information and the second spatial information,
obtain, based on the first object information and the second object information corresponding to a same location, third object information by combining the first object information and the second object information, and
obtain the map, wherein the map comprises the third spatial information and the third object information.

11. A controlling method of an electronic apparatus, the method comprising:
based on receiving a request for a map corresponding to a target space, obtaining first surface data for a first surface corresponding to a driving direction of the electronic apparatus based on first sensor data obtained in first driving for the target space;
obtaining second surface data for a second surface different from the first surface based on second sensor data obtained in second driving for the target space; and
obtaining the map based on the first surface data and the second surface data.

12. The controlling method of claim 11, wherein the first surface data comprises first information corresponding to a horizontal surface including an x axis and a y axis based on the driving direction of the electronic apparatus, and
wherein the second surface data comprises second information corresponding to a vertical surface including a z axis based on the driving direction of the electronic apparatus.

13. The controlling method of claim 11, wherein the first surface data comprises first spatial information of the first surface and first object information of the first surface.

14. The controlling method of claim 13, wherein the electronic apparatus comprises a first distance sensor and an acceleration sensor,
wherein the first sensor data comprises first distance data obtained through the first distance sensor and first acceleration data obtained through the acceleration sensor, and wherein the obtaining the first surface data comprises:
detecting first edge information based on the first distance data;
obtaining first direction information of the electronic apparatus based on the first acceleration data; and
obtaining the first surface data based on the first edge information and the first direction information.

15. The controlling method of claim 14, wherein the second surface data comprises second spatial information of the second surface and second object information of the second surface.
